(19) United States
(12) Patent Application Publication
(10) Pub. No.: US 2025/0053359 A1
(43) Pub. Date: Feb. 13, 2025

(54) PRINTING JOB TRANSMISSION METHOD, AND PRINTING JOB TRANSMISSION SYSTEM PREPARATION SYSTEM

(71) Applicant: CANON KABUSHIKI KAISHA, Tokyo (JP)

(72) Inventors: RYOYA KAWAI, Kanagawa (JP); SHU IWATA, Kanagawa (JP); HIROYOSHI IWAYAMA, Kanagawa (JP); JUMPEI TAKEICHI, Kanagawa (JP); KOHEI SONODA, Kanagawa (JP); KENTO KAWAI, Kanagawa (JP); SHODAI YANO, Tokyo (JP)

(21) Appl. No.: 18/795,299

(22) Filed: Aug. 6, 2024

(30) Foreign Application Priority Data
Aug. 10, 2023 (JP) 2023-131266
Aug. 10, 2023 (JP) 2023-131355
Aug. 10, 2023 (JP) 2023-131366
Aug. 10, 2023 (JP) 2023-131414
Aug. 10, 2023 (JP) 2023-131440
Aug. 10, 2023 (JP) 2023-131454
Aug. 10, 2023 (JP) 2023-131480

(51) Int. Cl. G06F 3/12

(52) U.S. Cl. CPC G06F 3/1287; G06F 3/1222; G06F 3/1238; G06F 3/1265; G06F 3/1288; G06F 3/1286

(57) ABSTRACT

A system including a printing apparatus, a first terminal, and a second terminal, wherein the first terminal includes a first transmission unit configured to transmit a printing job for causing the printing apparatus to execute printing, the second terminal includes a reception unit configured to receive inputting of predetermined information generated based on the transmission of the printing job by the first terminal, and a second transmission unit configured to transmit, based on the reception of inputting of the predetermined information, a request for causing the printing apparatus to execute printing based on the printing job transmitted by the first terminal, and the printing apparatus includes a printing unit configured to execute, based on the transmission of the request, printing based on the printing job transmitted by the first terminal.

### BACKGROUND OF THE DISCLOSURE

### Field of the Disclosure

The present disclosure relates to a printing job transmission method and a printing job transmission system for transmitting a printing job to an image forming apparatus.

### Description of the Related Art

Recently, a cloud print service that registers a printing job through a network service called a cloud and transmits the printing job to an image forming apparatus has started to become widespread. In a printing system using such a cloud print service, a user belonging to a tenant that uses the cloud print service registers an image forming apparatus corresponding to the cloud print service. Accordingly, the user belonging to the tenant becomes able to use the image forming apparatus through the cloud print service.

In the present disclosure, a tenant is a service system deployed on a cloud and has a storage region access to which is restricted to the tenant and a user belonging to the tenant. For example, an employee who works for a company “A” is registered as a user to a company “A” tenant of a cloud print service used in the company “A”. It is possible to cause an image forming apparatus under management of the company “A” to perform printing by giving instructions related to printing from a client terminal in the company to the image forming apparatus.

Due to diversification of work styles, a document stored in a client terminal in a company is often printed by using an image forming apparatus installed out of management of the company “A” in a home, a shared office, a convenience store, a library, a train station, or the like. It is becoming able to register an image forming apparatus installed out of management of the company “A” to the cloud print service. Moreover, it is becoming able to use a client terminal from inside and outside the company. Such a service can be used when a user belonging to the tenant of the company “A” associates an image forming apparatus or client terminal installed outside the company with the cloud print service.

At printing in such a cloud print service, when a printing job is received from a client terminal such as a personal computer, a job code for identifying the printing job is issued and notified to the client terminal. A user can use the job code to cause the image forming apparatus to execute printing based on the printing job of interest. In addition, a function is provided to set expire date to a printing job held at the cloud print service and a job code corresponding thereto so that any printing job the expire date of which has passed is automatically deleted.

As for use of a cloud print service, for example, two use cases of “printing using an image forming apparatus installed in a company” (hereinafter referred to as “in-company printing”) and “printing using an image forming apparatus installed at a place such as a shared office or a home outside a company” (hereinafter referred to as “out-of-company printing”) can be assumed. Specific examples of situations in which these use cases can be applied include a case where a remote worker prints business materials in a home or a shared office and a situation where a remote worker prints materials to be distributed to customers in a home or a shared office before going out. In addition, a situation where materials to be printed in a home are printed in a company in advance to check whether printing settings have problems is included.

In this manner, in a cloud print service, it is needed to be able to access printing data from each image forming apparatus inside or outside a company. Japanese Patent Laid-Open No. 2022-154408 (hereinafter referred to as the literature) discloses an example of technologies for cooperating different tenants in a cloud print service in a more preferable aspect to enable printing from image forming apparatuses inside and outside a company.

Conventionally, such a cloud print service has been intended to allow each tenant and an image forming apparatus to be used in cooperation. The cloud print service has been configured to receive a printing job from a client terminal so that printing based on the printing job is executed through operations on the image forming apparatus. However, due to diversification of work styles, and widespread of remote work in particular, it is becoming required to perform printing based on a printing job by using a smaller image forming apparatus installed in a home or a shared office. In this case, an image forming apparatus not equipped with an operation panel or an image forming apparatus equipped with a small operation panel is used, and thus it has been difficult to perform operations related to printing based on a printing job, and accordingly, usability is low. Furthermore, security improvement is required due to diversification of an installation place of an image forming apparatus.

### SUMMARY OF THE DISCLOSURE

An aspect of the present disclosure is a system including a printing apparatus, a first terminal, and a second terminal, wherein the first terminal includes a first transmission unit configured to transmit a printing job for causing the printing apparatus to execute printing, the second terminal includes a reception unit configured to receive inputting of predetermined information generated based on the transmission of the printing job by the first terminal, and a second transmission unit configured to transmit, based on the reception of inputting of the predetermined information, a request for causing the printing apparatus to execute printing based on the printing job transmitted by the first terminal, and the printing apparatus includes a printing unit configured to execute, based on the transmission of the request, printing based on the printing job transmitted by the first terminal.

Further features of the present disclosure will become apparent from the following description of exemplary embodiments with reference to the attached drawings.

### BRIEF DESCRIPTION OF THE DRAWINGS

FIG. 1 is a conceptual diagram illustrating the configuration of a system according to a first embodiment, a second embodiment, and a fourth embodiment;

FIG. 2 is a block diagram illustrating a hardware configuration of an information processing apparatus;

FIG. 3 is a functional block diagram of the information processing apparatus;

FIG. 4A is a table listing information stored in a remote work cloud print service, and FIG. 4B is a table listing information stored in a household cloud print service;

FIGS. 5A and 5B are tables listing printing-job related information;

FIG. 6 is a table listing model information;

FIG. 7 is a diagram for description of a method of registering a printer to an authentication server;

FIG. 8 is a table listing an example of information used for application authentication;

FIG. 9 is a table listing an example of information used for application authentication;

FIG. 10 is a diagram for description of a method of registering a printer to a mobile terminal;

FIG. 11 is a sequence diagram for description of printing job registration;

FIG. 12 is a sequence diagram for description of transmission of a printing job to an image forming apparatus in the first embodiment;

FIG. 13 is a sequence diagram for description of a preparation phase of application authentication;

FIG. 14 is a sequence diagram for description of an operation phase of application authentication;

FIG. 15 is another sequence diagram for description of the operation phase of application authentication;

FIG. 16 is a flowchart for description of processing of printing job registration by a client terminal;

FIGS. 17A to 17D are diagrams illustrating screens displayed on the client terminal;

FIG. 18 is a sequence diagram for description of an example of processing of user authentication at the client terminal;

FIG. 19 is a sequence diagram for description of another example of processing of user authentication at the client terminal;

FIGS. 20A and 20B are diagrams illustrating screens displayed on the mobile terminal;

FIG. 21 is a flowchart illustrating operation for switching display and non-display of buttons on the mobile terminal;

FIG. 22 is a table listing the model information;

FIG. 23 is a flowchart for description of processing related to printing job transmission request at the mobile terminal;

FIG. 24 is a sequence diagram for description of processing of deleting a printing job in accordance with a request from the client terminal;

FIG. 25 is a sequence diagram for description of processing of deleting a printing job in accordance with a request from the mobile terminal;

FIG. 26 is a sequence diagram for description of transmission of a printing job to an image forming apparatus in the second embodiment;

FIG. 27 is a sequence diagram for description of a method of user authentication at the mobile terminal;

FIGS. 28A and 28B are diagrams illustrating screens that the mobile terminal displays for authentication in the second embodiment;

FIG. 29 is a table listing information that an authentication server holds for authentication in the second embodiment;

FIG. 30 is a conceptual diagram illustrating the configuration of a system according to a third embodiment;

FIG. 31 is a table listing information that a push notification server holds;

FIG. 32 is a table listing information pushed to the mobile terminal;

FIG. 33 is a sequence diagram for description of a method for enabling push notification;

FIG. 34 is a diagram illustrating a screen including a mobile terminal registration QR code (registered trademark) that the client terminal displays;

FIG. 35 is a sequence diagram for description of a method of activating an app for requesting printing job transmission at the mobile terminal by a push notification;

FIG. 36 is a diagram illustrating a screen that the mobile terminal having received a push notification displays;

FIG. 37 is a flowchart for description of processing until an app for requesting printing job transmission requests printing job transmission after activated;

FIG. 38 is a sequence diagram for description of a method of performing user authentication at the client terminal;

FIG. 39 is a sequence diagram for description of a method until the mobile terminal requests printing job transmission after reading a QR code (registered trademark) including a job code and displayed on the client terminal;

FIG. 40 is a diagram of a screen including a QR code (registered trademark) that the client terminal having received a push notification displays; and

FIG. 41 is a table listing information included in a QR code (registered trademark) that the client terminal having received a push notification displays.

### DESCRIPTION OF THE EMBODIMENTS

Preferable embodiments of the present disclosure will be described below in detail with reference to the accompanying drawings. The embodiments described below do not limit the present disclosure according to the claims, and not all combinations of characteristics described in the embodiments are necessarily essential to means for solution of the present disclosure.

### First Embodiment

### <1. System Configuration>

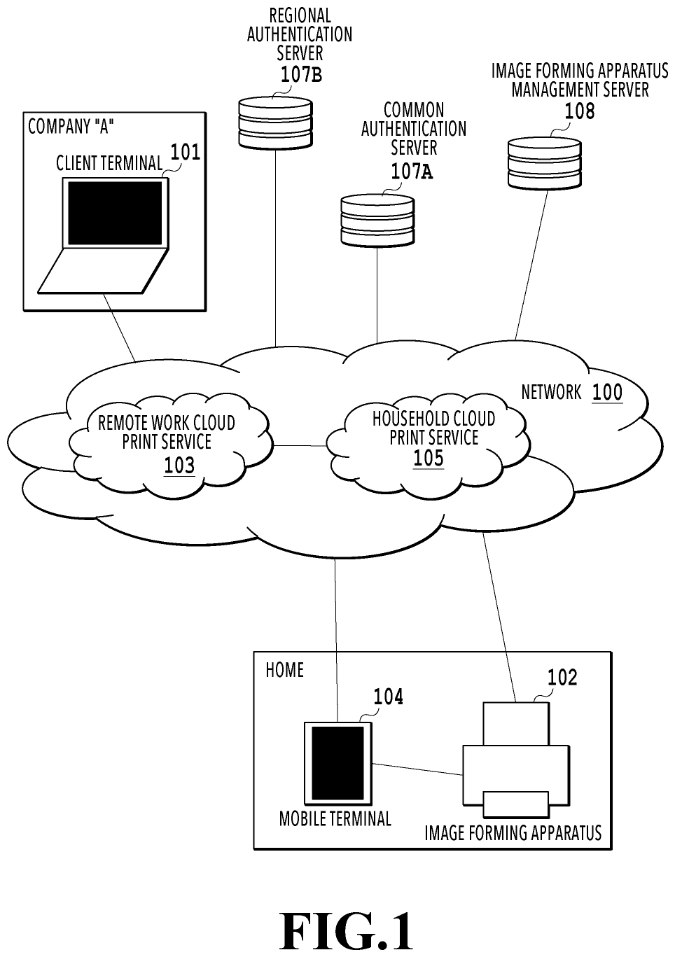

An example of a system configuration of a printing job transmission system according to a first embodiment will be described below with reference to FIG. 1. The system illustrated in FIG. 1 includes a remote work cloud print service (also referred to as an “input side cloud print service” or a “remote work service”) 103 that is an example of a cloud print service. The remote work service 103 is mainly used by a remote worker and the remote worker can register a printing job from a client terminal 101 such as a personal computer (hereinafter also referred to as a “PC”) used in a home or a shared office. Printing based on the registered printing job is performed by the remote worker through an image forming apparatus 102 installed in the home or the shared office. An instruction to transmit the printing job to the image forming apparatus 102 is executed from a mobile terminal 104 such as a smartphone used by the remote worker. The mobile terminal 104 instructs a household cloud print service (also referred to as an “output side cloud print service” or a “household service”) 105 to transmit the printing job to the image forming apparatus 102. In such a remote work service 103, a system administrator of a company “A” can understand a printing situation (for example, the number of sheets to be printed) at a place outside the company, such as a user home or a shared office under management of the company “A”. With this mechanism, consumables (for example, ink, toner, and sheet) of the image forming apparatus 102 installed at a place outside the company, such as a home or a shared office can be managed and used for, for example, expense reimbursement and usage audits. Moreover, the remote worker can perform printing in business without going to the company, and improvement of business efficiency can be expected. Further, printing through a cloud can be safely and reliably performed, and leakage of information in the company can be prevented. The remote work service 103 is a cloud service that achieves secure printing in such remote work and with which the company administrator can understand a printing situation.

The remote work service 103 schematically indicates a cloud print service that can be used by a user (for example, an employee) under management of the company “A”. The client terminal 101 schematically indicates a client terminal such as a PC used by the user in remote work. The image forming apparatus 102 schematically indicates an image forming apparatus registered to the remote work service 103 and the household service 105 by the user. As described later, the image forming apparatus 102 is registered to the remote work service 103 in association with user identification information. The image forming apparatus 102 is registered to the household service 105 in association with mobile terminal identification information that is identification information of the mobile terminal 104. The image forming apparatus 102 is installed at a place outside the company, such as a home. The mobile terminal 104 schematically indicates a mobile terminal that can be always used by the user in remote work. The mobile terminal 104 may be under management of the company “A” or may be owned by the user and not managed by the company “A”. The household service 105 schematically indicates a cloud print service capable of transmitting a printing job to the image forming apparatus 102. A service cooperating with the remote work service 103 exists as part of the cloud print service. A printing job registered to the remote work service 103 through the cooperation is transmitted to the image forming apparatus 102 through the household service 105 based on an instruction from the mobile terminal 104. Accordingly, the image forming apparatus 102 can perform printing based on the printing job registered to the remote work service 103. Typically, the remote work service 103 is under management of the company “A” and thus limited to access from the client terminal 101 managed by the company “A”. Although not illustrated, access to the remote work service 103 from a home is permitted in some cases. The household service 105 is not managed by the company “A” and can be accessed by any of the client terminal 101 managed by the company “A” and the mobile terminal 104 not managed by the company “A”.

In FIG. 1, the company “A” and the home are separately illustrated for sake of simplicity, but actual usage is not limited thereto. For example, the client terminal 101 may be any terminal managed by the company “A” and may be used in a home. The client terminal 101 under management of the company “A” is not limited to a PC but may be a smartphone or a tablet.

With such a configuration, for example, when having received printing job data (hereinafter also simply referred to as a “printing job”) from the client terminal 101, the remote work service 103 issues a job code that is a unique identifier for the printing job.

Thereafter, when having received a printing job transmission request and a job code from the mobile terminal 104 that is authenticated, the household service 105 obtains the printing job corresponding to the job code from the remote work service 103. Then, the household service 105 transmits the printing job to the image forming apparatus 102.

In the following description, a tenant of the company “A” is also referred to as an “in-company tenant” for sake of simplicity. A plurality of client terminals 101, a plurality of image forming apparatuses 102, and a plurality of mobile terminals 104 may exist.

Constituent components described above are connected to one another to perform mutual communication through a predetermined network 100. The network 100 is not limited to a particular type as long as data can be transmitted and received between constituent components described above. As a specific example, any of the Internet, a LAN, a WAN, a phone line, a dedicated digital line, an ATM, and the like, or combination thereof may be applied as the above-described network 100.

In the first embodiment, the remote work service 103 have a function corresponding to printing job registration and a function to issue a job code. The configuration illustrated in FIG. 1 is merely exemplary and does not necessarily limit the configuration of the printing job transmission system according to the first embodiment. As a specific example, the remote work service 103 may also function as the household service 105. As another example, the household service 105 may also function as the remote work service 103. In this manner, functions of two or more cloud print services among the set of cloud print services illustrated in FIG. 1 may be implemented by one cloud print service.

An example of the configuration of the printing job transmission system according to the first embodiment will be described below with reference to FIG. 1. The system illustrated in FIG. 1 includes the remote work service 103, the client terminal 101, the image forming apparatus 102, the mobile terminal 104, and the household service 105 exemplarily illustrated in FIG. 1. In addition, the system includes an authentication server 107 for executing processing related to authentication when the remote work service 103 and the household service 105 are used. Further, the system includes an image forming apparatus management server (also referred to as “apparatus management server”) 108 for executing processing related to authentication of the image forming apparatus 102. An authentication server corresponding to the remote work service 103 and an authentication server corresponding to the household service 105 may be separated or integrated. As described later, the authentication server corresponding to the household service 105 may be constituted by a common authentication server and a regional authentication server.

The authentication server 107 schematically indicates an authentication server used by each of the client terminal 101 and the mobile terminal 104 when accessing the remote work service 103 and the household service 105, respectively. The image forming apparatus management server 108 schematically indicates an image forming apparatus management server that executes processing related to management of the image forming apparatus 102 using the remote work service 103 and the household service 105.

With such a configuration, the authentication server corresponding to the household service 105 is intended to authenticate an individual application mounted on the mobile terminal 104 and corresponds to authentication using an app account ID. The above-described method is not a limiting example but may be any scheme by which an individual application can be authenticated, and the authentication server may correspond to, for example, authentication by a one-time password scheme.

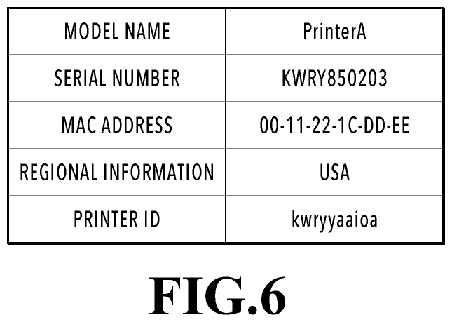

In a method of authenticating an individual application, for example, the mobile terminal 104 obtains, from the image forming apparatus 102 owned by the user, model information of the image forming apparatus 102, which is illustrated in FIG. 6, to authenticate the mobile terminal 104 itself. Then, the mobile terminal 104 transmits the model information to the authentication server 107 and requests authentication information.

Specifically, the mobile terminal 104 transmits a model name, a serial number, regional information, and an image forming apparatus ID (hereinafter also referred to as a “printer ID” or “printer identification information”) to the authentication server 107 and requests authentication information. Having received the model information of the image forming apparatus 102, the authentication server 107 checks whether the received model information of the image forming apparatus 102 is appropriate, and transmits authentication information (app account ID) to the mobile terminal 104 in a case where it is checked that the model information is legitimate.

An exemplary method of checking whether the received model information of the image forming apparatus 102 is appropriate is achieved through cooperation of the authentication server 107 with the image forming apparatus management server 108.

For example, in a case where the image forming apparatus 102 is installed in the home of the user, the image forming apparatus 102 transmits, in response to an operation by the user without delay, model information (model name, serial number, and regional information) to the image forming apparatus management server 108 by using a communication function provided to the apparatus. The image forming apparatus management server 108 receives the model information (the model name, the serial number, and the regional information as the model information of the image forming apparatus 102) and issues a printer ID corresponding to the model information. The printer ID is apparatus identification information for uniquely identifying each image forming apparatus. After the issue, the mobile terminal 104 obtains the printer ID corresponding to the image forming apparatus 102 from the image forming apparatus management server 108 and stores the printer ID in the mobile terminal 104. Then, the mobile terminal 104 transmits the printer ID to the authentication server 107 when the authentication server 107 is used. The authentication server 107 transmits the printer ID received from the mobile terminal 104 to the image forming apparatus management server 108. The image forming apparatus management server 108 checks whether the received printer ID is a printer ID issued and managed by the image forming apparatus management server 108. Accordingly, the authentication server 107 checks that the received model information of the image forming apparatus 102 is appropriate.

The image forming apparatus management server 108 receives the model name, the serial number, and the regional information included in the model information of the image forming apparatus 102 and issues a printer ID. The mobile terminal 104 causes the image forming apparatus management server 108 to issue the printer ID corresponding to the image forming apparatus 102 and stores the printer ID in the mobile terminal 104 in advance.

The mobile terminal 104 requests transmission of a printing job registered to the remote work service 103 by the client terminal 101 to the image forming apparatus 102, and this request is referred to as a “printing job transmission request”. When issuing the printing job transmission request, the mobile terminal 104 transmits authentication information (app account ID) received from the authentication server 107 and stored to the authentication server 107 and requests an access token. Thus, the user does not need to input authentication information to the mobile terminal 104 when the printing job transmission request is issued. Having received the authentication information, the authentication server 107 checks whether the received authentication information is issued and managed by the authentication server 107. Accordingly, when having checked that the authentication information is appropriate, the authentication server 107 transmits an access token and the URL of the household service 105 to be accessed to the mobile terminal 104.

In authentication performed when the printing job transmission request is issued, authentication information (app account ID) stored in the mobile terminal 104 (in particular, an application mounted on the mobile terminal) is used. The authentication information is stored only in the mobile terminal 104. It is managed such that the authentication information is not stored in any terminal such as another mobile terminal. Thus, with this authentication, one account is provided to one application, and in this sense, the authentication is referred to as “Account of App authentication” or “AOA authentication” below. In a case where a plurality of mobile terminals 104 are associated with one image forming apparatus 102, an app account ID is provided to an application mounted on each mobile terminal 104. Thus, in a case where the same image forming apparatus 102 is used from different mobile terminals 104, authentication is performed with different app account IDs. In this sense, the “AOA authentication” is “terminal authentication”. In addition, an “app account ID” is “terminal authentication information”. It is premised that only one authentication target application is mounted on each mobile terminal 104.

Authentication with which one count is provided for one user is referred to as “One Account for One Person authentication” or “OAO authentication” below.

In the first embodiment, the authentication server 107 can perform both AOA authentication and OAO authentication. The authentication server 107 functions as a terminal authentication server when performing AOA authentication, and functions as a user authentication server when performing OAO authentication.

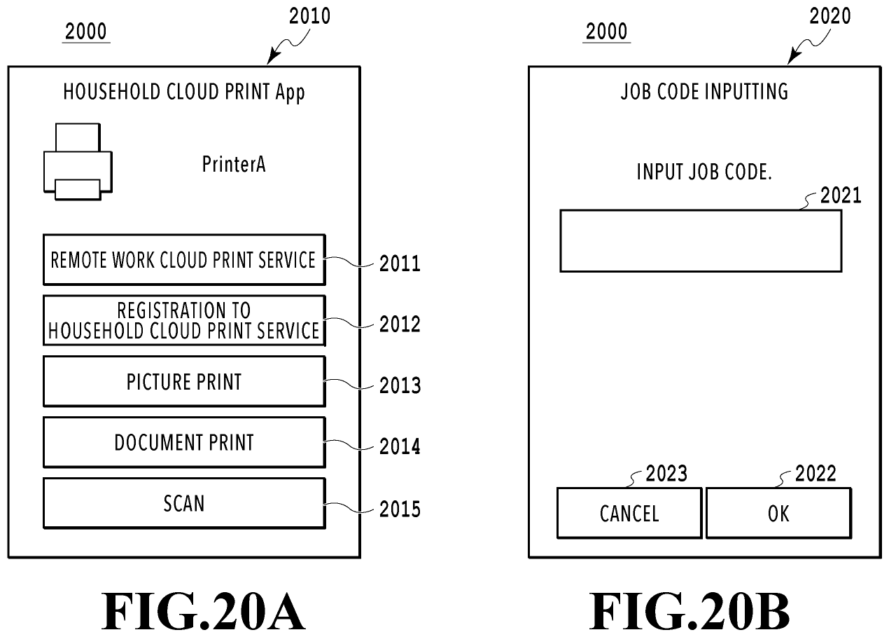

Thereafter, the mobile terminal 104 accesses the household service 105 by using the access token and the URL of the household service 105 to be accessed, which are received from the authentication server 107. Having received the access token, the household service 105 transmits the access token to the authentication server 107. The authentication server 107 checks whether the received access token is issued and managed by the authentication server 107. Accordingly, in a case where it is checked that the access token is appropriate, the check is notified to the household service 105. Having received the notification, the household service 105 transmits screen data to the mobile terminal 104. As a specific example, data of a screen 2020 as illustrated in FIG. 20B may be transmitted. The mobile terminal 104 can present the screen 2020 to the user based on the received data of the screen 2020.

A plurality of client terminals 101, a plurality of image forming apparatuses 102, and a plurality of mobile terminals 104 may exist.

Constituent components described above are connected to one another to perform mutual communication through the predetermined network 100. The network 100 is not limited to a particular type as long as data can be transmitted and received between constituent components described above. As a specific example, any of the Internet, a LAN, a WAN, a phone line, a dedicated digital line, an ATM, and the like, or combination thereof may be applied as the above-described network 100.

In the first embodiment, the authentication server 107 and the image forming apparatus management server 108 are implemented as separated cloud services so that the authentication server 107 issues authentication information in cooperation with the image forming apparatus management server 108. However, the configuration illustrated in FIG. 1 is merely exemplary and does not necessarily limit the configuration of the printing job transmission system according to the first embodiment. As a specific example, the authentication server 107 may also function as the image forming apparatus management server 108. In this manner, functions of two or more cloud services among the set of cloud services illustrated in FIG. 1 may be implemented by one cloud service. The authentication server 107 and the image forming apparatus management server 108 may be different depending on regions.

### <2. Hardware Configuration of Information Processing Apparatus>

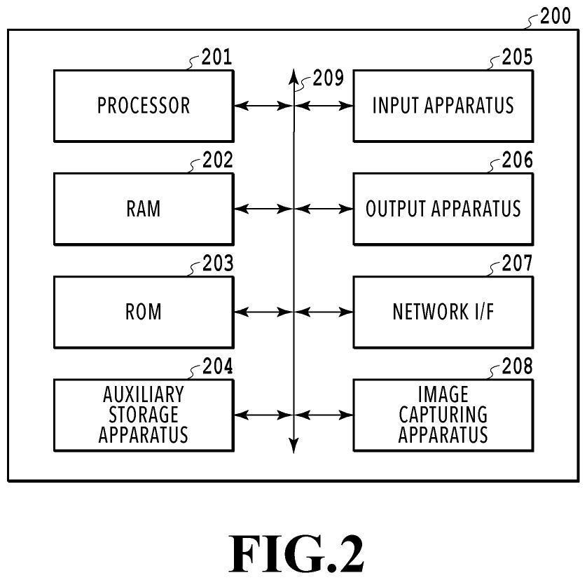

An example of a hardware configuration of an information processing apparatus 200 included in a system according to an embodiment of the present disclosure will be described below with reference to FIG. 2. The information processing apparatus 200 according to the first embodiment includes a processor 201 such as a central processing unit (CPU), a random access memory (RAM) 202, and a read only memory (ROM) 203. The information processing apparatus 200 also includes an auxiliary storage apparatus 204 and a network I/F 207. The information processing apparatus 200 may also include at least one of an input apparatus 205 and an output apparatus 206. In addition, the information processing apparatus 200 may include an image capturing apparatus 208. The processor 201, the RAM 202, the ROM 203, the auxiliary storage apparatus 204, the input apparatus 205, the output apparatus 206, the network I/F 207, and the image capturing apparatus 208 are mutually connected through a bus 209.

The processor 201 is a central processing unit that controls various kinds of operation of the information processing apparatus 200. For example, the processor 201 may control operation of the entire information processing apparatus 200. The RAM 202 is a main storage memory of the processor 201 and used as a work area or a temporary storage region onto which various computer programs are loaded. The ROM 203 stores, for example, a computer program (such as BIOS) for the processor 201 to control operation of the information processing apparatus 200. The auxiliary storage apparatus 204 stores an operating system (OS) as basic software, computer programs such as various applications, and various kinds of data. The auxiliary storage apparatus 204 may be achieved by, for example, a non-transitory memory such as a hard disk drive (HDD) or a solid state drive (SSD). The input apparatus 205 is an apparatus for receiving an instruction from the user. The input apparatus 205 may be achieved by, for example, a pointing device such as a mouse, and operation devices such as a keyboard and a touch panel. The output apparatus 206 is an apparatus for presenting various kinds of information to the user. The output apparatus 206 may be achieved by a display device such as a display, which presents information to the user by displaying various kinds of display information, screens, and the like. The network I/F 207 is an interface connected to a predetermined network (for example, a LAN or the Internet) to perform communication with an external instrument through the network. The image capturing apparatus 208 is an apparatus that converts an image captured by an image capturing element into digital data. The digital data is temporarily stored in the RAM 202. Thereafter, the digital data is converted into a predetermined image format by a computer program executed by the processor 201 and is stored as image data in the auxiliary storage apparatus 204.

The above-described configuration is merely exemplary and does not necessarily limit the hardware configuration of the information processing apparatus 200. As a specific example, some constituent components (for example, at least one of the input apparatus 205 and the output apparatus 206) among the plurality of above-described constituent components included in the information processing apparatus 200 may be externally mounted outside the information processing apparatus 200.

Functional configurations and processing to be described later are implemented when the desired information processing apparatus 200 loads computer programs stored in the ROM 203 and the auxiliary storage apparatus 204 onto the RAM 202 and then executes the computer programs.

### <3. Functional Configuration of Information Processing Apparatus>

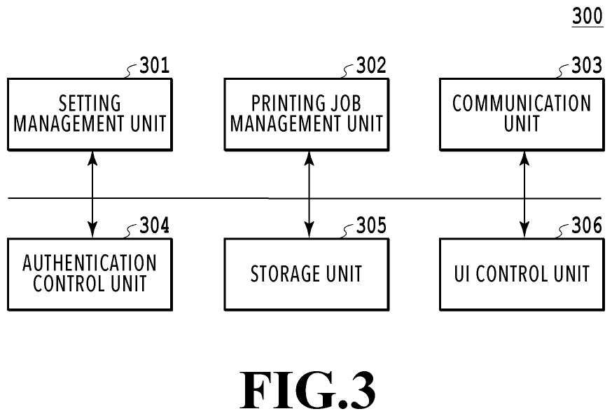

The following description with reference to FIG. 3 will be made mainly on an example of a functional configuration of the information processing apparatus included in the printing job transmission system according to the first embodiment, particularly, a configuration related to provision of the remote work service 103 and the household service 105. The remote work service 103 and the household service 105 may be configured by respective information processing apparatuses different from each other, or a plurality of cloud print services may be provided by one information processing apparatus. For sake of simplicity, the following description will be made mainly on a case where an information processing apparatus 300 executes various kinds of processing related to provision of the remote work service 103, but the same description in effect is applicable to a case where the household service 105 is provided. The description is made on the configuration of the information processing apparatus 300 when executing various kinds of processing of the remote work service 103, but is the same for the configuration of the information processing apparatus 300 when executing various kinds of processing of the household service 105.

The information processing apparatus 300 includes a setting management unit 301, a printing job management unit 302, a communication unit 303, an authentication control unit 304, a storage unit 305, and a UI control unit 306. The information processing apparatus 300 is configured based on the information processing apparatus 200 having the hardware configuration illustrated in FIG. 2. Accordingly, the information processing apparatus 300 can function as an input side service apparatus that is an information processing apparatus on which a server for providing the remote work service 103 is mounted. Similarly, the information processing apparatus 300 can function as an output side service apparatus that is an information processing apparatus on which a server for providing the household service 105 is mounted.

The setting management unit 301 stores and holds setting information related to various kinds of functions of the remote work service 103 in a predetermined storage region (for example, the RAM 203 or the auxiliary storage apparatus 204) and reads the setting information from the storage region based on a desired trigger. The setting information includes, for example, tenant information and printing job information related to a registered printing job (for example, the expire date of the printing job).

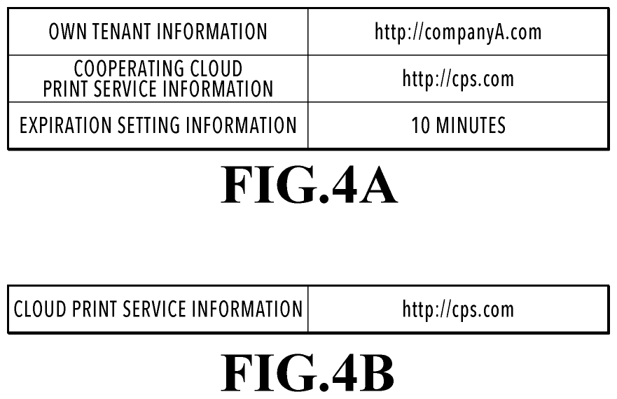

For example, FIGS. 4A and 4B each illustrate an example of setting information of a cloud print service. Specifically, FIG. 4A illustrates an example of setting information of an in-company tenant (for example, a tenant of the company “A”) of the remote work service 103. FIG. 4B illustrates an example of setting information of the household service 105.

The following first describes an example of setting information of an in-company tenant of the remote work service 103, which is illustrated as FIG. 4A. “Own tenant information” is information for specifying an in-company tenant (for example, a tenant of the company “A”) and is set to information such as a URL. In the example illustrated in FIG. 4A, “http://companyA.com” is set as the own tenant information. Information set as the own tenant information is not limited to a particular type but may be any information with which an in-company tenant can be specified, and may be set to an identifier such as a tenant ID.

“Cooperating cloud print service information” is information based on which the remote work service 103 associated with the in-company tenant specifies the household service 105 used as, for example, the transmission destination of a printing job. The “cooperating cloud print service information” is set to information such as a URL. In the example illustrated in FIG. 4A, “http://cps.com” is set as the cooperating cloud print service information. Information set as the cooperating cloud print service information is not limited to a particular type but may be any information with which a cooperating cloud print service can be specified, and may be set to, for example, an identifier such as a cloud print service ID.

“Expiration setting information” is an example of printing job information and is expire date setting information for determining the expire date of a printing job held by a cloud print service. In the example illustrated in FIG. 4A, “10 minutes” is set as the expiration setting information. This setting value has a value for determining the expire date of information related to a printing job held by the cloud print service and is applied not only to the tenant of the company “A” but also to each tenant in common.

The following describes an example of setting information of the household service 105, which is illustrated as FIG. 4B. “Cloud print service information” is information for specifying the household service 105 and is set to information such as a URL. In the example illustrated in FIG. 4B, “http://cps.com” is set as the cloud print service information. As in the in-company tenant example illustrated in FIG. 4A, information set as the cloud print service information is not limited to a particular type but may be any information with which a cloud print service can be specified.

The printing job management unit 302 obtains information related to a printing job from another apparatus (for example, the client terminal 101 or the mobile terminal 104) and stores the information in a predetermined storage region (for example, the storage unit 305). The printing job management unit 302 may obtain information related to a printing job from a cloud print service (for example, the remote work service 103) and store the information in the predetermined storage region.

The printing job management unit 302 corresponding to the remote work service 103 may determine whether out-of-company printing using a cloud print service is permitted for a printing job received from another apparatus (for example, the client terminal 101). The printing job management unit 302 may issue permission information related to execution of a printing job.

When having received the printing job transmission request with a designated job code from the mobile terminal 104, the printing job management unit 302 corresponding to the household service 105 obtains the corresponding printing job from the remote work service 103. The printing job management unit 302 corresponding to the household service 105 may transmit the obtained printing job to the image forming apparatus 102. A printer ID for specifying the image forming apparatus 102 is obtained from authentication information used in the above-described AOA authentication.

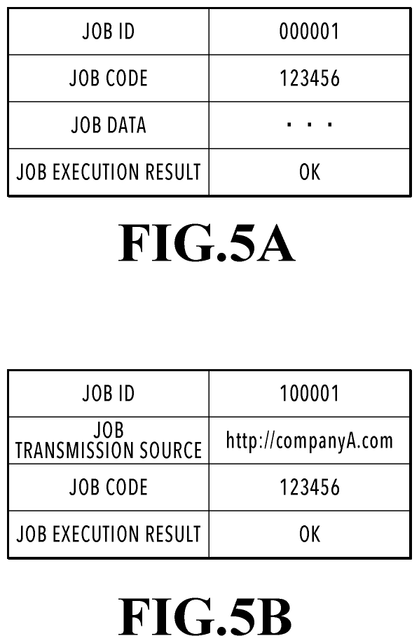

For example, FIGS. 5A and 5B each illustrate an example of a printing job and information related to the printing job, which are stored in a predetermined storage region by a cloud print service. Specifically, FIG. 5A illustrates an example of a printing job and information related to the printing job, which are stored in a predetermined storage region by a cloud print service (for example, the remote work service 103) corresponding to an in-company tenant. FIG. 5B illustrates an example of information related to a printing job and stored in a predetermined storage region by the household service 105.

The following first describes an example of a printing job and information related to the printing job, which are stored in a predetermined storage region by a cloud print service corresponding to an in-company tenant, the example being illustrated as FIG. 5A. The set of information illustrated in FIG. 5A is generated, for example, in the unit of printing job and stored in the predetermined storage region. For sake of simplicity, the following description will be made on each information illustrated as FIG. 5A based on an assumption that the information is managed by the remote work service 103.

“Printing job ID” is identification information (ID value) uniquely allocated by the remote work service 103 to manage a printing job and information related to the printing job.

“Job code” is issued for each printing job by the remote work service 103 for cooperation of the remote work service 103 and the household service 105. The job code is used to, for example, designate a printing job as a target of printing by the image forming apparatus 102. The job code is issued for a printing job to avoid duplication not only within a tenant but also among tenants. However, this is not a limiting example.

“Printing job data” is data of a printing job and is, for example, binary data. As a specific example, data of a printing job is data compliant with page description language (PDL), portable document format (PDF), JPEG, or the like. Instead of data of a printing job, information (for example, address) for accessing a document stored in an external storage may be set as “printing job data”.

“Printing job execution result” is information in accordance with a result of execution of a printing job by the image forming apparatus 102. In the example illustrated in FIG. 5A, “OK” indicating normal execution of printing is set as the printing job execution result. The printing job execution result is, for example, information that the remote work service 103 receives from the household service 105 together with a job code. In a case where an error has occurred at printing execution, for example, an error code may be set as the printing job execution result. In addition, any of color printing and monochrome printing, the number of pages, the number of sets, charging information, and the like may be included in the printing job execution result. In addition, information related to, for example, the date, time, and place of printing execution may be included in the printing job execution result.

The following describes an example of information related to a printing job and stored in a predetermined storage region by the household service 105, which is illustrated as FIG. 5B. The set of information illustrated in FIG. 5B is stored in, for example, a predetermined storage region. The predetermined storage region is generated in the unit of printing job each time the household service 105 receives a printing job. A storage region corresponding to one printing job has a size with which information related to one printing job can be stored.

“Printing job ID”, “job code”, and “printing job execution result” are the same as those illustrated in FIG. 5A, and thus duplicate description thereof is omitted.

“Printing job transmission source” is information for specifying a cloud print service (for example, the remote work service 103) that transmits information related to a printing job to the household service 105, and is set to information such as a URL. In the example illustrated in FIG. 5B, “http://companyA.com” is set as the printing job transmission source.

The communication unit 303 performs transmission and reception of various kinds of data with other apparatuses (for example, the client terminal 101, the image forming apparatus 102, and the mobile terminal 104). For example, the communication unit 303 may receive a printing job, a printing job execution request, and the like from the other apparatuses. The communication unit 303 may receive various processing requests from another cloud print service and may transmit information in accordance with processing results to the other cloud print service.

The authentication control unit 304 executes various kinds of processing related to user management. The authentication control unit 304 may store information related to a user added in accordance with an instruction from an administrator of a tenant in a predetermined storage region (for example, the storage unit 305 to be described later). As another example, the authentication control unit 304 may cooperate with an external authentication service to perform management of information related to a user.

The storage unit 305 stores various kinds of data. For example, the storage unit 305 may store various kinds of data in accordance with requests from the printing job management unit 302 and the authentication control unit 304.

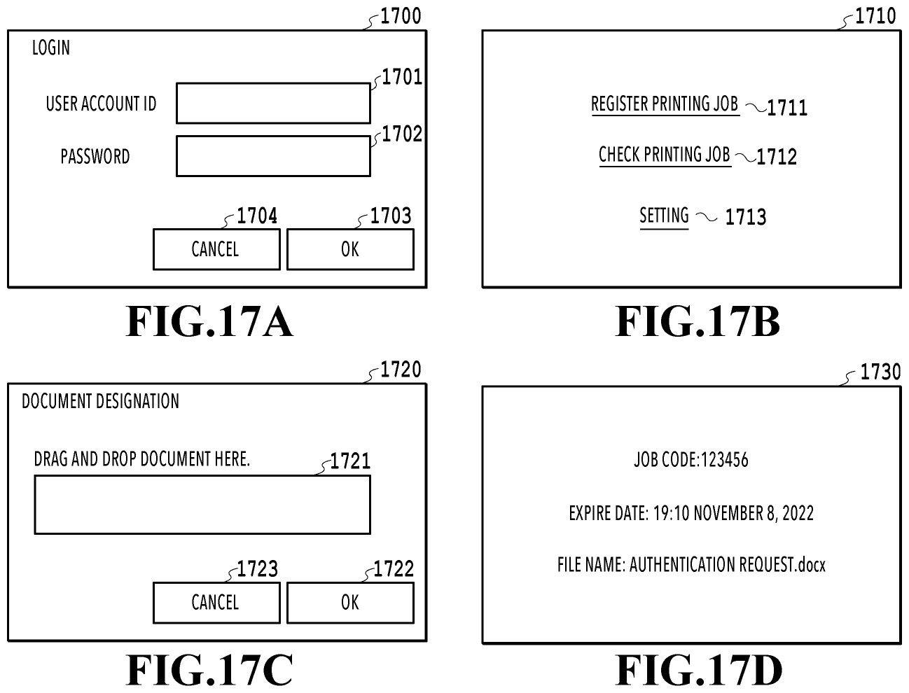

The UI control unit 306 executes reception of inputs from a user in accordance with requests from other apparatuses (for example, the client terminal 101, the image forming apparatus 102, and the mobile terminal 104). The UI control unit 306 also executes processing for generating and outputting a UI for achieving presentation various kinds of information to the user. As a specific example, the UI control unit 306 may generate a screen in accordance with a request from a browser operating on the client terminal 101 or the mobile terminal 104. Then, the UI control unit 306 may transmit the screen (or data related to outputting of the screen) to the client terminal 101 or the mobile terminal 104 through the communication unit 303. Accordingly, the above-described screen generated by the UI control unit 306 is presented to the user through the browser operating on the above-described client terminal 101 or mobile terminal 104. The screen is, for example, screens to be described later with reference to FIGS. 17A to 17D.

The following description with reference to FIG. 3 will be made mainly on an example of a functional configuration of an information processing apparatus included in the printing job transmission system according to the first embodiment, particularly, a configuration related to provision of the client terminal 101 and the mobile terminal 104. The client terminal 101 and the mobile terminal 104 may be configured by respective information processing apparatuses different from each other or may be provided by one information processing apparatus. For sake of simplicity, the following description will be made mainly on a case where the information processing apparatus 300 executes various kinds of processing related to provision of the mobile terminal 104, but the same description in effect is applicable to a case where the client terminal 101 is provided.

The setting management unit 301 stores and holds, in a predetermined storage region, setting information related to various kinds of functions of an application installed to use the remote work service 103 and the household service 105. The predetermined storage region is, for example, the RAM 202 or the auxiliary storage apparatus 204. Then, the setting management unit 301 reads the setting information from the storage region based on a desired trigger. The setting information includes, for example, the model information of the image forming apparatus 102 (for example, the model name of the image forming apparatus 102 and a printer ID for uniquely specifying the image forming apparatus 102).

For example, FIG. 6 illustrates an example of the model information of the image forming apparatus 102. “Model name” is information indicating the name of the image forming apparatus 102. In the example illustrated in FIG. 6, “PrinterA” is set as the model name. Information set as the model name is not particularly limited but may be any information with which the type of the image forming apparatus 102 can be specified, and may be set to an identifier such as a model ID.

“Serial number” is information for specifying the image forming apparatus 102. In the example illustrated in FIG. 6, “KWRY850203” is set as the serial number. Information set as the serial number is not particularly limited but may be any information with which the image forming apparatus 102 can be specified, and may be in any format.

“MAC address” is information for specifying the image forming apparatus in the second layer of an OSI reference model. In the example illustrated in FIG. 6, “00-11-22-1C-DD-EE” is set as the MAC address.

“Regional information” is information for specifying a region in which the image forming apparatus 102 is installed. In the example illustrated in FIG. 6, “USA” is set as the regional information. Information set as the regional information is not particularly limited but may be any information with which a region can be specified, and may be set to an identifier such as a region ID.

“Printer ID” is information with which the remote work service 103 and the household service 105 uniquely specify the image forming apparatus 102. In the example illustrated in FIG. 6, “kwryyaaioa” is set as the printer ID. The printer ID is information for identifying the image forming apparatus 102 registered to the remote work service 103 and the household service 105, and is information applied in common among the cloud print services. The printer ID may be managed and issued in cooperation with a printer ID management service provided by the image forming apparatus management server 108.

The printing job management unit 302 obtains information related to the image forming apparatus 102 from the image forming apparatus 102 and stores the information in a predetermined storage region (for example, the storage unit 305). The printing job management unit 302 may determine whether the image forming apparatus 102 corresponds to the remote work service 103 and the household service 105 by using the information related to the image forming apparatus 102 and received from the image forming apparatus 102. The printing job management unit 302 may transmit the information related to the image forming apparatus 102 and received from the image forming apparatus 102 to the remote work service 103 and the household service 105. The transmitted information related to the image forming apparatus 102 is the same as information described above with reference to FIG. 6, and the household service 105 stores the same information as in FIG. 6 in the predetermined storage region.

The communication unit 303 performs transmission and reception of various kinds of data with other apparatuses (for example, the image forming apparatus 102, the remote work service 103, and the household service 105). For example, the communication unit 303 may receive information related to the image forming apparatus 102 from the image forming apparatus 102. The communication unit 303 may receive various processing requests from the remote work service 103 and the household service 105 and may transmit information in accordance with processing results to the cloud print services.

The authentication control unit 304 executes various kinds of processing related to user management. The authentication control unit 304 may generate information related to a user who uses the remote work service 103 and the household service 105, and may store the information in a predetermined storage region (for example, the storage unit 305 to be described later). As another example, the authentication control unit 304 may cooperate with an external authentication service to perform management of information related to a user.

The storage unit 305 stores various kinds of data. For example, the storage unit 305 may store various kinds of data in accordance with requests from the printing job management unit 302.

The UI control unit 306 executes processing for generating and outputting a UI for achieving reception of inputs from a user and presentation of various kinds of information to the user in accordance with requests from other apparatuses. The other apparatuses are, for example, the image forming apparatus 102, the remote work service 103, and the household service 105. As a specific example, the UI control unit 306 may receive a screen (or data related to outputting of the screen) generated by the remote work service 103 or the household service 105 through the communication unit 303. Accordingly, the UI control unit 306 presents the received screen to the user through a browser operating on the mobile terminal 104.

### <4. Registration of Image Forming Apparatus to Various Servers>

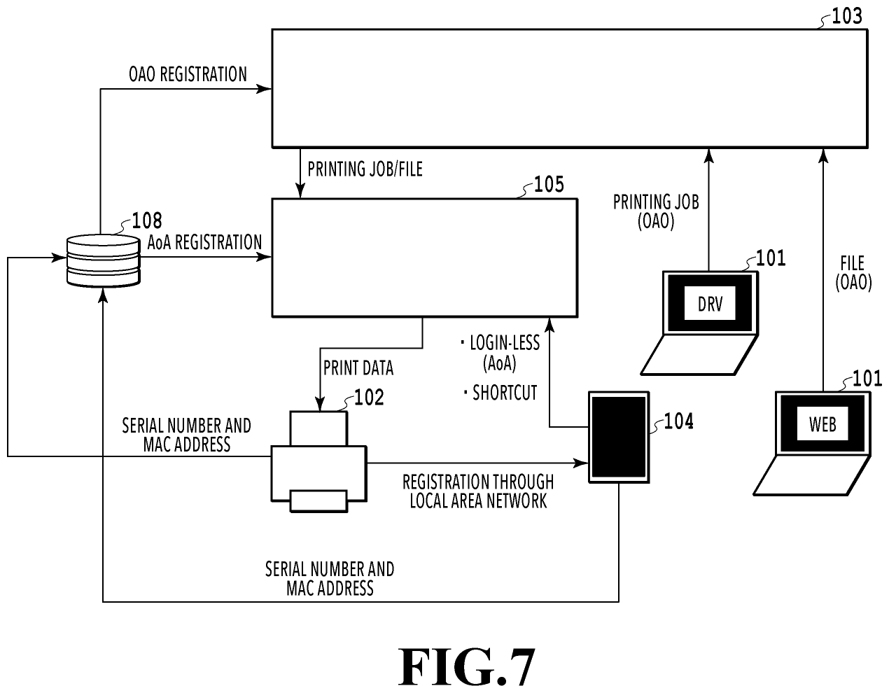

A method of registering the image forming apparatus 102 to the image forming apparatus management server 108 and the authentication server 107 will be described below with reference to FIG. 7. The description will be made based on an assumption that the authentication server 107 corresponds to both the remote work service 103 and the household service 105, but separate authentication servers may correspond to the respective services.

First, the image forming apparatus 102 is registered to the image forming apparatus management server 108. At the registration, the image forming apparatus 102 transmits the serial number and MAC address of the own apparatus to the image forming apparatus management server 108. The image forming apparatus management server 108 applies a printer ID for the pair of the serial number and the MAC address and transmits the printer ID to the image forming apparatus 102. The image forming apparatus 102 stores the printer ID in the own apparatus. In addition, the image forming apparatus management server 108 obtains model information corresponding to the serial number and transmits the model information to the image forming apparatus 102. The image forming apparatus 102 stores the model information in the own apparatus.

Subsequently, the image forming apparatus 102 is registered to the remote work service 103. Specifically, the printer ID is registered to the remote work service 103 in association with a user account ID (user account identification information). Accordingly, the user can use the remote work service 103 through OAO authentication. The remote work service 103 can obtain the printer ID corresponding to the user account ID used in OAO authentication. At the registration, the authentication server corresponding to the remote work service 103 checks whether the image forming apparatus 102 specified by the printer ID is registered in the image forming apparatus management server 108 in a proper manner. Only in a case where the check is successful, the printer ID and the user account ID are registered in association to the remote work service 103.

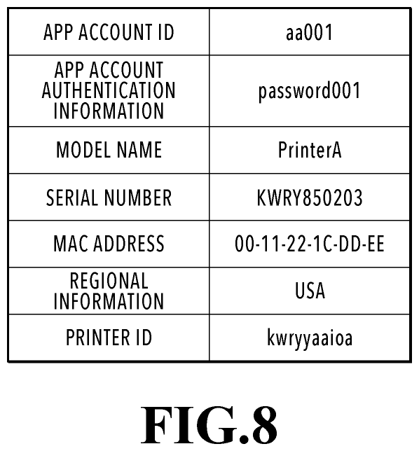

Information as illustrated in FIG. 8 is stored in the authentication server corresponding to the household service 105 in AOA authentication.

As illustrated in FIG. 8, “app account information” is information that the authentication server issues for each cloud print application (also referred to as an “application”) 2000 (FIGS. 20A and 20B) mounted on the mobile terminal 104 accessing the authentication server. For example, information such as an app account ID is set as the app account information. In the example illustrated in FIG. 8, “aa001” is set as the account information.

“App account authentication information” is information that the authentication server issues for each application 2000 on the mobile terminal accessing the authentication server, and is set to information such as a password. In the example illustrated in FIG. 8, “password001” is set as the app account authentication information.

“Model name”, “serial number”, “MAC address”, “regional information”, and “printer ID” are the same as the printer ID of the image forming apparatus 102 described above with reference to FIG. 6.

In this manner, the app account authentication information and the model information of the image forming apparatus can be stored in association in the storage unit 305 of the authentication server.

In this manner, the printer ID and the app account ID are registered in association to the authentication server corresponding to the household service 105. At the registration, the authentication server corresponding to the household service 105 checks whether the image forming apparatus 102 specified by the printer ID is registered in the image forming apparatus management server 108 in a proper manner. Only in a case where the check is successful, the app account ID and the printer ID of the image forming apparatus 102 are registered in association to the authentication server corresponding to the household service 105. Accordingly, the user can use the household service 105 by satisfying a predetermined condition through AOA authentication. The household service 105 can obtain the printer ID corresponding to the app account ID used in AOA authentication. As described later, when AOA authentication is enabled, the household service 105 can obtain a printer ID at each AOA authentication. Thus, the household service 105 can designate the image forming apparatus 102 to be used for cloud print by using the printer ID obtained from AOA authentication. Normally, the printer ID needs to be registered in advance to use the household service 105, but this registration is unnecessary when AOA authentication is enabled.

For example, a user installs the image forming apparatus 102 in a home and then performs initial setting. The image forming apparatus 102 is first registered to the image forming apparatus management server 108 as the user performs a predetermined operation through a user interface of the image forming apparatus 102. Alternatively, the image forming apparatus 102 may be registered to the image forming apparatus management server 108 as the user performs a predetermined operation through a user interface of an information processing apparatus connected to the image forming apparatus 102 through, for example, a home LAN. In this case, the serial number and MAC address of the image forming apparatus 102 are transmitted from the image forming apparatus 102 to the image forming apparatus management server 108, and the image forming apparatus management server 108 issues a printer ID for the pair of the serial number and the MAC address. The image forming apparatus 102 can be registered, based on the serial number and MAC address of the image forming apparatus 102, to the information processing apparatus connected to the image forming apparatus 102 through the home LAN. Alternatively, the image forming apparatus 102 may be registered, based on the printer ID, to the information processing apparatus connected to the image forming apparatus 102 through the home LAN. The image forming apparatus management server 108 includes a database for storing model information (model name, serial number, regional information, cloud print support information (also referred to as “support information”)) each of model of the image forming apparatus 102. Thus, the model information may be held and transmitted in association with the printer ID associated with the serial number and MAC address of the image forming apparatus 102. The regional information may be associated with the serial number of the image forming apparatus 102 in advance or may be set based on a region in which the image forming apparatus 102 is installed.

When the client terminal 101 accesses the remote work service 103 based on an operation by the user, the client terminal 101 first performs OAO authentication. In a case where the OAO authentication is successful, a WEB page (not illustrated) of the remote work service 103 is displayed on the client terminal 101. When a printer registration button disposed on the WEB page is pressed, a WEB page (not illustrated) for registering the image forming apparatus 102 to the remote work service 103 is displayed. The user inputs a printer ID to the registration WEB page. A user account ID used in the OAO authentication and the printer ID input to the registration WEB page are transmitted to an authentication server for the remote work service 103. Then, the printer ID and the user account ID are associated with each other and registered to the remote work service 103. As described later, the user account ID is transmitted from the client terminal 101 to the remote work service 103 in OAO authentication before the client terminal 101 registers a printing job to the remote work service 103. Accordingly, the image forming apparatus 102 identified by the printer ID associated with the user account ID can be designated as the transmission destination of the printing job. Through the above-described registration, OAO authentication information (user account ID and password) and the printer ID are stored in association in the remote work service 103.

### <5. Registration of Image Forming Apparatus to Mobile Terminal>

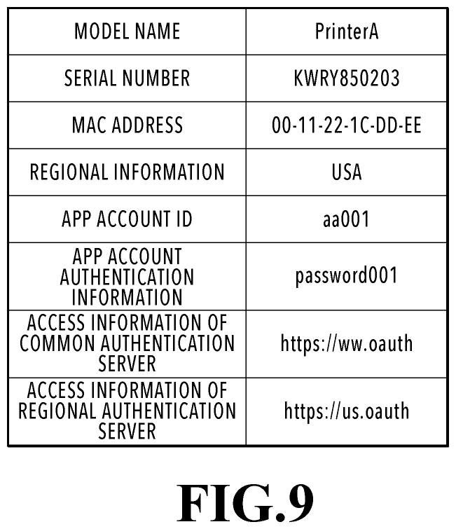

Information as illustrated in FIG. 9 is stored in the mobile terminal 104 in AOA authentication.

As illustrated in FIG. 9, “model name”, “serial number”, “MAC address”, “regional information”, “app account ID”, and “app account authentication information” are the same as information held by the authentication server corresponding to the household service 105 in AOA authentication. The mobile terminal 104 does not hold “printer ID”. “Access information of common authentication server” and “access information of regional authentication server” are information for accessing the common authentication server and the regional authentication server, respectively.

“Access information of common authentication server” is access information of a common authentication server 107A that is common worldwide. “Access information of regional authentication server” is access information of a regional authentication server 107B, which is received from the common authentication server 107A.

When the user performs a predetermined operation on the mobile terminal 104, the image forming apparatus 102 can be registered, based on the serial number and MAC address of the image forming apparatus 102, to the mobile terminal 104 connected to the image forming apparatus 102 through the home LAN. Alternatively, the image forming apparatus 102 can be registered to the mobile terminal 104 based on the printer ID.

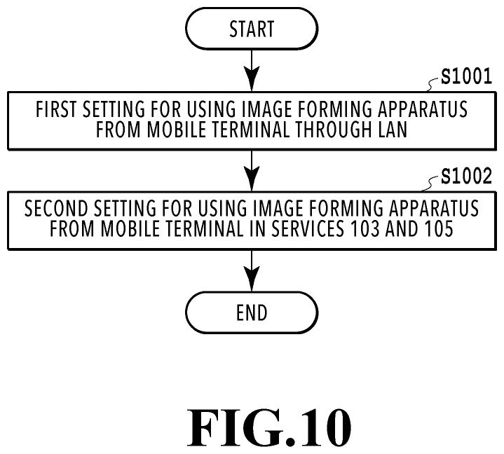

As illustrated in FIG. 10, at S1001, for example, the image forming apparatus 102 is registered to the mobile terminal 104 so that the image forming apparatus 102 can be used from the mobile terminal 104 in a home local area network (LAN). This corresponds to “registration in local area network” illustrated in FIG. 7. Based on the registration, a “picture print” button 2013, a “document print” button 2014, and a “scan” button 2015 disposed on a screen 2010 illustrated in FIG. 20A are activated. Specifically, for example, pictures and documents stored in the mobile terminal 104 can be printed by the image forming apparatus 102 in accordance with instructions from the mobile terminal 104. Moreover, documents can be scanned by the image forming apparatus 102 and stored in the mobile terminal 104 in accordance with instructions from the mobile terminal 104.

At S1002, a printer ID that is identification information of the image forming apparatus 102 is registered to the remote work service 103 in association with a user account ID that is identification information of the user. This corresponds to “OAO registration” illustrated in FIG. 7. In addition, at S1002, the printer ID is registered to the household service 105 in association with an app account ID. This corresponds to “AOA registration” illustrated in FIG. 7. Accordingly, a printing job registered to the remote work service 103 from the client terminal 101 can be transmitted to the image forming apparatus 102 through the remote work service 103 and the household service 105 in accordance with an instruction from the mobile terminal 104. Details of S1002 will be described later.

### <6. Overall Processing Flow>

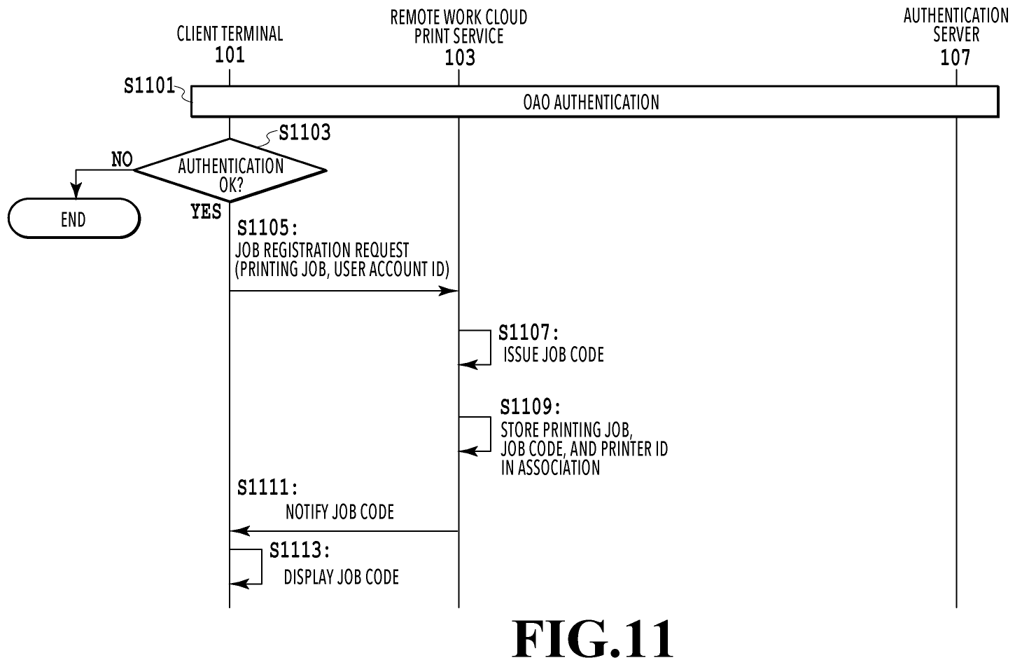

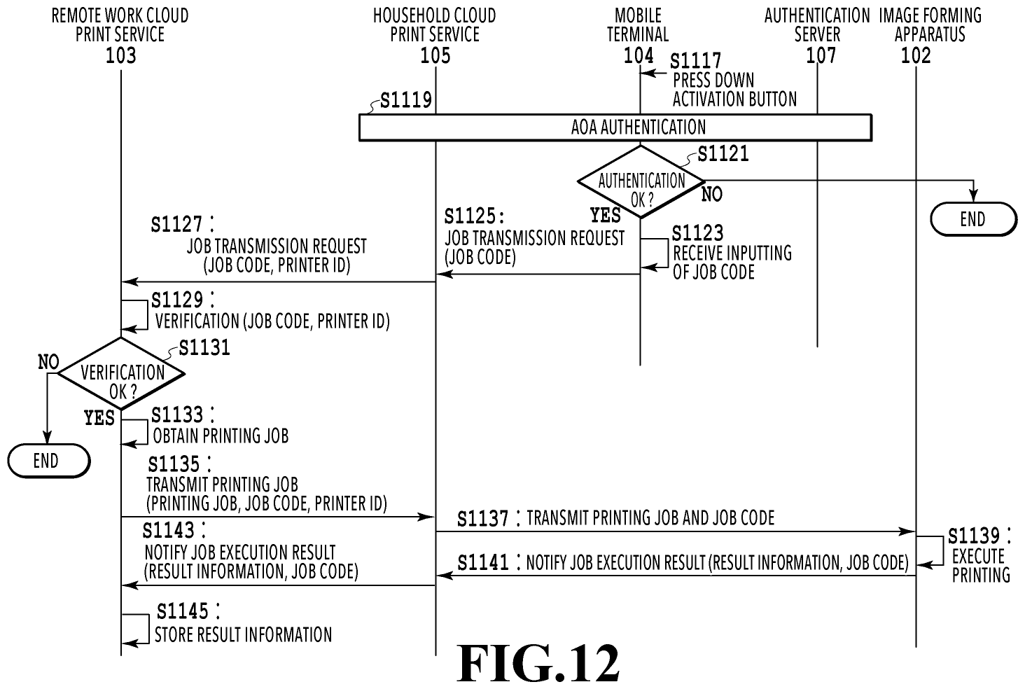

An example of a processing sequence of transmitting a printing job to the image forming apparatus 102 based on an transmission instruction from the user will be described below with reference to FIGS. 11 and 12. In the processing sequence, the client terminal 101, the image forming apparatus 102, the remote work service 103, the mobile terminal 104, and the household service 105 cooperate.

As illustrated in FIG. 11, at S1101, the client terminal 101 performs OAO authentication to use the remote work service 103. In the OAO authentication, the user inputs a user account ID and a password to the client terminal 101. In the OAO authentication, the remote work service 103 obtains the printer ID corresponding to the user account ID.

At S1103, the client terminal 101 checks whether the OAO authentication is successful, and advances the processing to S1105 in a case where the OAO authentication is successful.

At S1105, the client terminal 101 transmits a printing job registration request to the remote work service 103. A printing job and the user account ID are attached to the printing job registration request.

At S1107, the remote work service 103 issues a job code to be allocated to the printing job attached to the job registration request received at S1105.

At S1109, the remote work service 103 stores the printing job attached to the job registration request received at S1105, the printer ID obtained in the OAO authentication at S1101, and the job code issued at S1107 in association with one another.

At S1111, the remote work service 103 notifies the client terminal 101 of the job code.

At S1113, the client terminal 101 displays the job code on a screen.

As illustrated in FIG. 12, at S1117, an activation button (for example, a “remote work cloud print service” button 2011 disposed on the screen 2010 illustrated in FIG. 20A) displayed by an application operating on the mobile terminal 104 is pressed down by the user.

At S1119, the mobile terminal 104 performs AOA authentication to use the household service 105. In the AOA authentication, the user does not need to input an app account ID to the mobile terminal 104 and the application transmits an app account ID (refer to FIG. 9) stored in the mobile terminal 104 to an authentication server. In the AOA authentication, the household service 105 obtains a printer ID from the authentication server 107.

At S1121, it is checked whether the AOA authentication is successful, and the processing is advanced to S1123 in a case where the AOA authentication is successful.

At S1123, the mobile terminal 104 receives inputting of a job code by the user. It is assumed that the user sees the job code displayed on the screen by the client terminal 101 at S1113 and inputs the job code to the mobile terminal 104. Steps in place of S1123 will be described in a third embodiment and a fourth embodiment.

At S1125, the mobile terminal 104 requests the household service 105 for printing job transmission with attachment of the job code received at S1123.

At S1127, the household service 105 transmits a printing job transmission request to the remote work service 103. The job code received at S1125 and the printer ID obtained in the AOA authentication at S1119 are attached to the printing job transmission request.

At S1129, the remote work service 103 verifies the job code and the printer ID attached to the printing job transmission request received at S1127. In the verification, the job code and the printer ID stored at S1111 are used. Specifically, it is checked whether the pair of the job code and the printer ID attached to the printing job transmission request received at S1127 match the pair of the job code and the printer ID stored at S1109.

At S1131, it is checked whether the verification is successful, and the processing is advanced to S1133 in a case where the verification is successful.

At S1133, the remote work service 103 obtains the printing job stored at S1109 by using the job code and the printer ID attached to the job transmission request received at S1127 as keys.

At S1135, the remote work service 103 transmits the printing job obtained at S1133 and the job code and the printer ID attached to the job transmission request received at S1127 to the household service 105.

At S1137, the household service 105 transmits the printing job and the job code received at S1135 to the image forming apparatus 102 identified based on the printer ID received at S1135.

At S1139, the image forming apparatus 102 executes printing based on the printing job received at S1137.

At S1141, the image forming apparatus 102 transmits a printing job execution result to the household service 105 with attachment of the job code. The printing job execution result includes result information indicating whether the printing is successful.

At S1143, the household service 105 forwards the printing job execution result to the remote work service 103.

At S1145, the remote work service 103 stores the result information received at S1143.

The expire date of the printing job may be provided, information with which the expire date can be determined may be stored together with the printing job and the like at S1109, and it may be checked whether the expire date has passed at S1131.

### <7. AOA Authentication at Mobile Terminal>

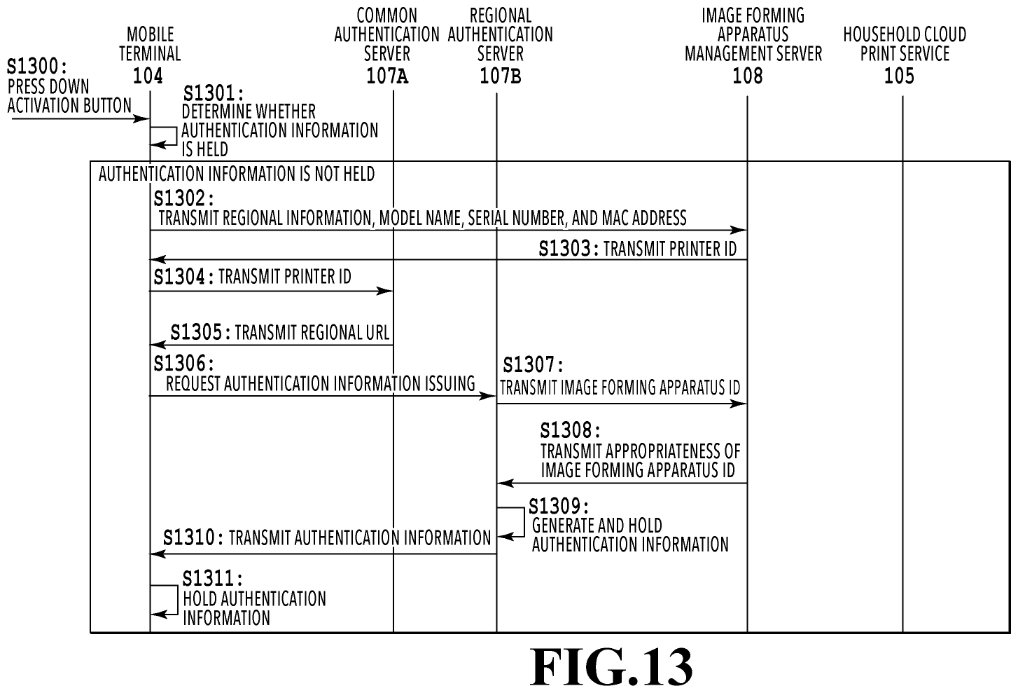

Processing illustrated in FIGS. 13 to 15 starts, for example, in a case where a “remote work service” button 2011 on the screen 2010 in FIG. 20A is pressed down. In FIG. 13, this press-down is indicated as activation button press-down (S1300). The activation button press-down assumes that the processing at S1101 to S1113 is already executed.

The processing illustrated in FIGS. 13 to 15 is executed in accordance with, for example, a user instruction through a display unit, an input apparatus, or the like of the mobile terminal 104, or a user instruction received by an application installed on the mobile terminal 104. It is assumed in the following description that the application 2000 and a browser are used to receive user instructions. In this case, the browser may operate as part of the application 2000 or may operate as an external application different from the application 2000.

At S1301, based on the press-down of the “remote work service” button 2011 on the screen 2010, the authentication control unit 304 of the mobile terminal 104 checks whether authentication information is already received from the regional authentication server 107B and held in the storage unit 305. Specifically, it is checked whether authentication information corresponding to the image forming apparatus 102 registered to the application 2000 is stored in the storage unit 305 of the mobile terminal 104. The processing is advanced to S1401 in a case where the authentication information is stored in the storage unit 305 of the mobile terminal 104, or the processing is advanced to S1302 in a case where the authentication information is not stored. The authentication information includes the printer ID, the app account ID, the app account authentication information, the access information (for example, URL) of the common authentication server 107A, and the access information (for example, URL) of the regional authentication server 107B illustrated in FIG. 9.

At S1302, the authentication control unit 304 of the mobile terminal 104 requests the image forming apparatus management server 108 for the printer ID of the image forming apparatus 102 registered to the app 2000 through the communication unit 303. For example, the model name, serial number, MAC address, and regional information of the image forming apparatus 102 registered to the app 2000 are attached to the request.

At S1303, the image forming apparatus management server 108 transmits the printer ID of the image forming apparatus 102 registered to the app 2000 to the mobile terminal 104.

At S1304, the authentication control unit 304 of the mobile terminal 104 starts communication with the common authentication server 107A through the communication unit 303. Specifically, the authentication control unit 304 transmits the printer ID received at S1303 to the common authentication server 107A. The access information of the common authentication server 107A may be held by the application 2000 in advance or may be obtained from outside by the application 2000.

At S1305, the authentication control unit 304 of the common authentication server 107A transmits the access information (for example, the URL of https://us.oauth) of the regional authentication server 107B as a communication target to the mobile terminal 104.

At S1306, by using the access information received at S1305, the authentication control unit 304 of the mobile terminal 104 requests the regional authentication server 107B to issue authentication information through the communication unit 303. Specifically, the mobile terminal 104 transmits the printer ID to the regional authentication server 107B and requests issuing of the app account ID and the app account authentication information, which are described above with reference to FIG. 8.

At S1307, the authentication control unit 304 of the regional authentication server 107B requests the image forming apparatus management server 108 to check whether the printer ID received from the mobile terminal 104 is appropriate. Specifically, it is requested to check whether the printer ID is issued by the image forming apparatus management server 108. In the first embodiment, it is assumed that the printer ID is appropriate.

At S1308, the image forming apparatus management server 108 transmits information that the printer ID is appropriate to the regional authentication server 107B. Specifically, information indicating that the printer ID received at S1307 is issued by the image forming apparatus management server 108 is transmitted to the regional authentication server 107B.

At S1309, the authentication control unit 304 of the regional authentication server 107B generates an app account ID and app account authentication information in association with the printer ID received from the mobile terminal 104 and holds the app account ID and the app account authentication information in the storage unit 305 of the regional authentication server 107B. In addition, the model information (“model name”, “serial number”, “MAC address”, and “regional information”) of the image forming apparatus 102 may be stored as illustrated in FIG. 8. Thus, it can be said that the app account ID is issued in association with the printer ID.

At S1310, the authentication control unit 304 of the authentication server 107 transmits the app account ID and the app account authentication information generated at S1309 to the mobile terminal 104.

At S1311, the authentication control unit 304 of the mobile terminal 104 stores the access information of the regional authentication server 107B, which is received at S1305 in the storage unit 305 of the mobile terminal 104. The authentication control unit 304 of the mobile terminal 104 also stores the app account ID and the app account authentication information received at S1310 in the storage unit 305 of the mobile terminal 104. Specifically, the authentication control unit 304 of the mobile terminal 104 stores information as follows in the storage unit 305 of the mobile terminal 104. The information includes part of the model information of the image forming apparatus 102 selected by the application 2000, the app account ID, the app account authentication information, and the access information of the regional authentication server 107B. The part of the model information is the model name, the serial number, and the regional information.

In the above description, the app account ID and the app account authentication information are issued and stored in the regional authentication server 107B and the storage unit 305 of the mobile terminal 104. In this case, AOA authentication is performed with the app account ID and the app account authentication information. However, this is not a limiting example, and the app account authentication information may be omitted.

The processing at S1302 to S1311 is preparation processing for AOA authentication. The preparation processing may be performed at the first timing of AOA authentication or may be performed following registration of the image forming apparatus 102 to the application 2000.

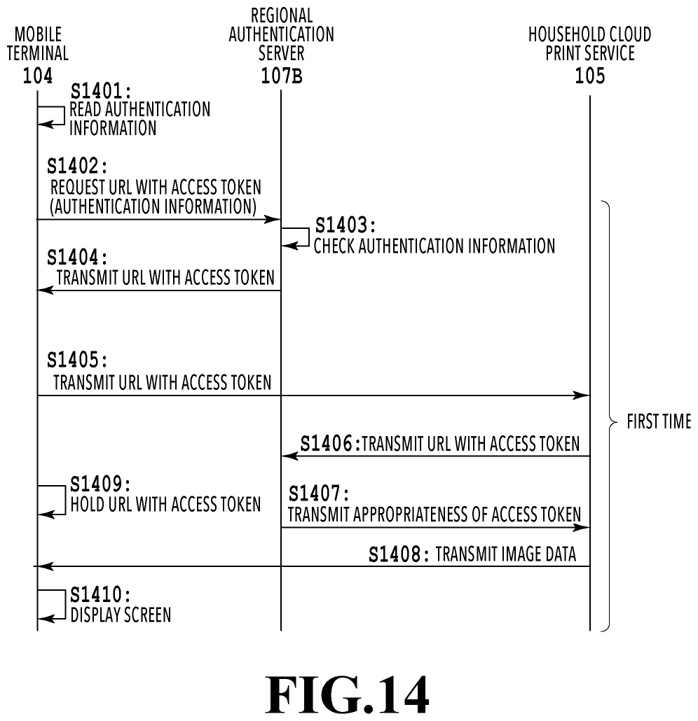

The processing at S1311 continues to S1401 illustrated in FIG. 14.

At S1401, the mobile terminal 104 reads the authentication information (the app account ID and the app account authentication information, in particular) stored at S1311.

At S1402, the authentication control unit 304 of the mobile terminal 104 requests the regional authentication server 107B to transmit access information with an access token. At the request for transmission of access information with an access token, the information stored in the storage unit 305 of the mobile terminal 104 at S1311 is transmitted to the regional authentication server 107B. The information stored in the storage unit 305 of the mobile terminal 104 at S1309 is the app account ID, the app account authentication information, and an identifier (such as an access destination ID) of the household service 105 as an access target. The application 2000 holds the identifier of the household service 105 in advance. Alternatively, the application 2000 may obtain the identifier of the household service 105 from outside before S1402.

At S1403, the regional authentication server 107B checks whether the app account ID and the app account authentication information received from the mobile terminal 104 are appropriate. Specifically, it is checked whether the received app account ID and app account authentication information match the app account ID and app account authentication information stored at S1309. In the first embodiment, it is assumed that the app account ID and the app account authentication information are appropriate.

At S1404, the authentication control unit 304 of the authentication server 107 transmits, to the mobile terminal 104, information for accessing the household service 105 indicated by the identifier received from the mobile terminal 104 at S1402. The information for accessing the household service 105 indicated by the identifier is access information with an access token (for example, a URL with an access token).

Thus, the authentication control unit 304 of the regional authentication server 107B receives the identifier of the household service 105 as an access target from the mobile terminal at S1402. Then, the authentication control unit 304 of the regional authentication server 107B generates access information with an access token by adding the access token to the access information (for example, URL) corresponding to the identifier and transmits the access information with the access token to the mobile terminal 104. The access token is stored in the regional authentication server 107B in association with the app account ID and used later at S1406 to check appropriateness of a transmitted access token.

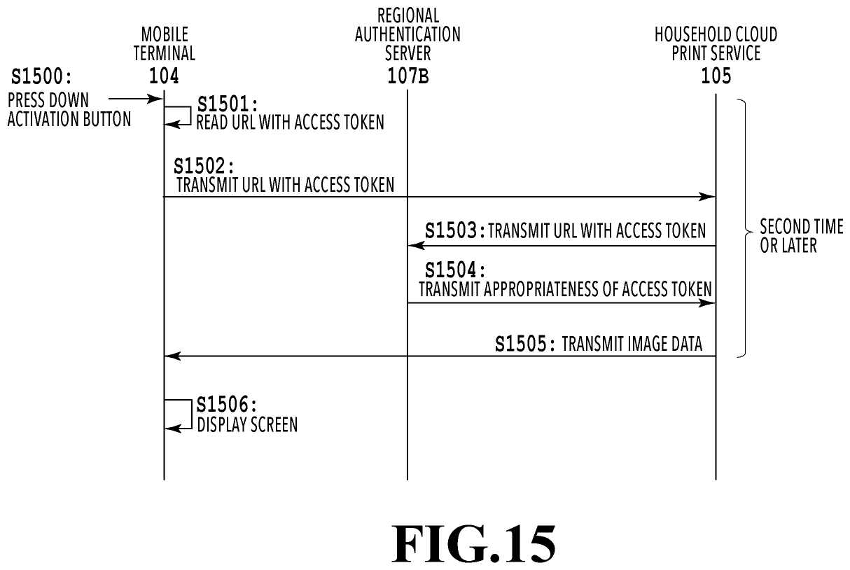

At the first access to the household service 105, S1405 is executed after the processing at S1301 to S1311 and the processing at S1401 to S1404 are executed. As illustrated in FIG. 15, processing at S1500 to S1502 is executed at the second access or later. S1500 corresponds to S1300, processing at S1502 to S1505 corresponds to S1405 to S1408, and S1506 corresponds to S1410. S1501 is a step of reading a URL with an access token, which is stored at S1409. The access token has a lifetime, and an error is returned to the mobile terminal 104 at S1502 in a case where the end of the lifetime is reached. In this case, the mobile terminal 104 executes the processing at S1401 to S1410 again.

At S1405, the authentication control unit 304 of the mobile terminal 104 accesses the household service 105 by using the access information with the access token, which is received at S1404. In the first embodiment, the authentication control unit 304 of the mobile terminal 104 transmits the access token to the household service 105 to access the household service 105.

At S1406, the authentication control unit 304 of the household service 105 checks whether the access token received from the mobile terminal 104 is appropriate. Specifically, the access token received from the mobile terminal 104 at S1405 is transmitted to the authentication server 107, and the authentication server 107 checks the access token is issued by the authentication server 107 and has a valid expire date. In the first embodiment, description will be made based on an assumption that it is checked that the access token is appropriate.

At S1407, the regional authentication server 107B transmits information that the access token is appropriate to the household service 105. Specifically, information indicating that the access token received at S1406 is issued by the authentication server 107 is transmitted to the household service 105. In addition, at S1407, the regional authentication server 107B transmits the printer ID to the household service 105. The regional authentication server 107B associates the URL with the access token, the authentication information, and the printer ID with one another.

At S1408, the authentication control unit 304 of the household service 105 transmits a screen (for example, the screen 2020 (FIG. 20B)) provided by the household service 105 and data related to the screen to the mobile terminal 104.

At S1410, the UI control unit 306 of the mobile terminal 104 displays the screen (for example, the screen 2020 (FIG. 20B)) provided by the household service 105 on a screen of the mobile terminal 104. In this case, the UI control unit 306 of the mobile terminal 104 uses the screen and the data related to the screen, which are received from the household service 105 at S1408.

After the screen display, the processing is advanced to S1123 (FIG. 12).

By using the present authentication processing, it is possible to determine whether the regional authentication server 107B that supports an access source region exists.

Specifically, at S1302, the authentication control unit 304 of the common authentication server 107A compares the regional information received from the mobile terminal 104 to a target country list held by the common authentication server 107A. In a case where the regional information is included in the target country list, the authentication control unit 304 of the common authentication server 107A determines that a region indicated by the regional information is supported by either regional authentication server 107B, and advances the processing to S1303. In a case where the regional information is not included in the target country list held by the common authentication server 107A, the authentication control unit 304 of the common authentication server 107A determines that the region indicated by the regional information is not supported by any regional authentication server 107B, and ends the processing.

Thus, according to the first embodiment, processing as follows may be executed before S1410 or S1506 of displaying a screen for requesting printing job transmission to the image forming apparatus 102. Specifically, only predetermined information registered to the application 2000 may be transmitted when the regional authentication server 107B is requested for the URL with the access token at S1402. The predetermined information is an app account ID and app account authentication information corresponding to the image forming apparatus 102, and the identifier (such as access destination ID) of the household service 105 as an access target. The app account ID and the app account authentication information are already stored in the storage unit 305 of the mobile terminal 104 at S1311. The app account authentication information may be omitted as described above.

Thus, authentication is automatically performed for the image forming apparatus 102 when the user only presses down the “remote work service” button 2011 displayed on the screen 2010 (FIG. 20A). Then, the screen 2020 for requesting printing job transmission to the image forming apparatus 102 is displayed.

Even in a case where the client terminal 101 is used, AOA authentication described above in the first embodiment can be used to execute processing that does not need individual user authentication. Specifically, even in a case where the client terminal 101 is used, AOA authentication described above in the first embodiment can be used for processing that requests printing job transmission to the image forming apparatus 102 by using a job code.

Such AOA authentication can improve usability and security of an authentication system in processing of transmitting a printing job to the image forming apparatus 102 by using the mobile terminal 104. The AOA authentication can be achieved by combination of the application 2000, the image forming apparatus 102, the authentication server 107, and the image forming apparatus management server 108.

Such AOA authentication is effective in a case where individual user authentication is unnecessary when a printing job is transmitted to the image forming apparatus 102 by using a job code at the mobile terminal 104.

However, in a case where a printing job is registered or the image forming apparatus 102 is registered on the client terminal 101, an individual user is authenticated by using OAO authentication using a user account ID and a password.

With such a method, it is possible to reduce user operations related to authentication in processing of transmitting a printing job to the image forming apparatus 102 by using the mobile terminal 104, thereby further improving usability and security of the authentication system.

### <8. Printing Job Registration at Client Terminal>

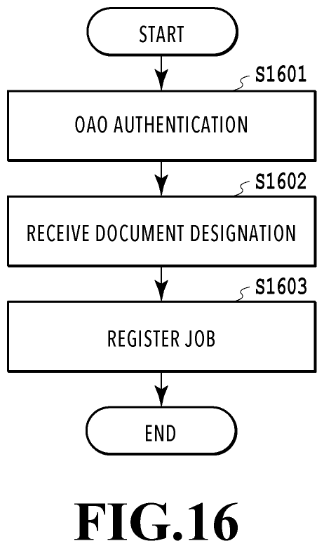

An example of processing related to printing job registration by a terminal such as the client terminal 101 or the mobile terminal 104 will be described below with reference to FIGS. 16 and 17A to 17D. For sake of simplicity, the following description will be made, with focus on a tenant of the company “A”, an example of processing at the client terminal 101 in a case where the client terminal 101 transmits a printing job to the remote work service 103.

A series of processing illustrated in FIG. 16 is executed in accordance with, for example, a user instructed through a display apparatus, an input apparatus, or the like of the client terminal 101, or a user instruction received by an application installed on the client terminal 101. It is assumed in the following description that a browser is used to receive user instructions. Specifically, the top screen of a UI related to use of the remote work service 103 is displayed based on the URL of “http://companyA.com” corresponding to the remote work service 103 and input to a URL input field of the browser.

For example, a screen 1700 illustrated in FIG. 17A illustrates an example of the top screen. The screen 1700 is a screen that receives inputting of information related to user authentication.

An input region 1701 is a region that receives inputting of an user account ID (user identification information) for user identification from the user. An input region 1702 is a region that receives inputting of a password used for user authentication from the user.

A button 1703 is a button for receiving, from the user, an instruction related to execution of user authentication based on the user account ID input to the input region 1701 and the password input to the input region 1702. A button 1704 is a button for receiving an instruction related to termination of use of the remote work service 103 from the user.

At S1601, the client terminal 101 receives inputting of a user account ID and a password to the input regions 1701 and 1702, respectively, on the screen 1700 and press-down of the button 1703. Then, the client terminal 101 transmits the user account ID and the password to the remote work service 103. The authentication control unit 304 of the remote work service 103 executes, based on the user account ID and the password transmitted from the client terminal 101, processing related to OAO authentication of the user corresponding to the user account ID. The authentication control unit 304 of the remote work service 103 may request a predetermined authentication service for the OAO authentication of the user. In a case where the OAO authentication of the user is successful in the processing at S1601, a screen 1710 illustrated in FIG. 17B is presented through the above-described browser. Specifically, the client terminal 101 obtains data of the screen 1710 by accessing the remote work service 103 and presents the screen 1710 to the user based on the data.

The screen 1710 illustrated in FIG. 17B is an example of a menu screen for receiving, from the user, an instruction related to display of a screen to be a user interface for using various kinds of functions. An item 1711 is an item for receiving, from the user, a display instruction of a screen associated with a function related to registration of a printing job. An item 1712 is an item for receiving, from the user, a display instruction of a screen associated with a function related to check of a registered printing job. An item 1713 is an item for receiving, from the user, a display instruction of a screen associated with a function related to check and change of various settings.

At S1602, the client terminal 101 receives designation of a printing target document from the user. Specifically, when the item 1711 is designated on the screen 1710 displayed at S1601, the client terminal 101 accesses the remote work service 103 and obtains data of a screen related to printing job registration. Then, the client terminal 101 presents this screen 1720 based on the data to the user. Then, the client terminal 101 receives designation of a printing target document from the user through the screen 1720.

The screen 1720 illustrated in FIG. 17C is an example of a screen for receiving an instruction related to designation of a printing target document from the user.

An input region 1721 is an input region for receiving designation of a printing target document from the user. An instruction related to document designation is received, for example, when data (such as a file) of a target document is dragged and dropped into the input region 1721 by using an input apparatus such as a mouse pointer. The data designation is not limited to a particular method as long as data of a target document can be specified. In the following description, information input to the input region 1721 is referred to as “document specification information”.

A button 1722 is a button for receiving, from the user, an instruction to register a printing job for printing a document specified by the document specification information. A button 1723 is a button for receiving an instruction to terminate printing job registration from the user.

At S1603, the client terminal 101 receives an instruction related to printing job registration based on information input to the screen 1720. Specifically, when the button 1722 is pressed down, the client terminal 101 transmits information input to the input region 1721 to the remote work service 103. Accordingly, printing job registration is requested for the remote work service 103. S1603 corresponds to S1105 illustrated in FIG. 11, and the processing continues to S1603 to S1107.

A screen 1730 illustrated in FIG. 17D is an example of a screen related to job code notification (S1111). Specifically, the screen 1730 is displayed by the job code display at S1113 illustrated in FIG. 11. The screen 1730 is transmitted from the remote work service 103 to the client terminal 101 at the job code notification at S1111 illustrated in FIG. 11. The screen 1730 may be transmitted by http or mail using smtp. The screen 1730 displays an issued job code. The screen 1730 may display, in addition to the job code, for example, the expire date of a printing job, and the file name of a document designated through the screen 1720. For example, date and time when time of “expiration setting information” in FIG. 4B elapses since a day on which the processing (S1603) related to printing job registration illustrated in FIG. 16 is executed is presented as the expire date. As a specific example, a printing job is registered at 19:00 on Nov. 8, 2022 in the example illustrated in FIG. 17D. In addition, 19:10 on Nov. 8, 2022, which is 10 minutes (value of the expiration setting information illustrated in FIG. 4B) after the registration, is set as the expire date of the printing job.

### <9. OAO Authentication at Client Terminal>

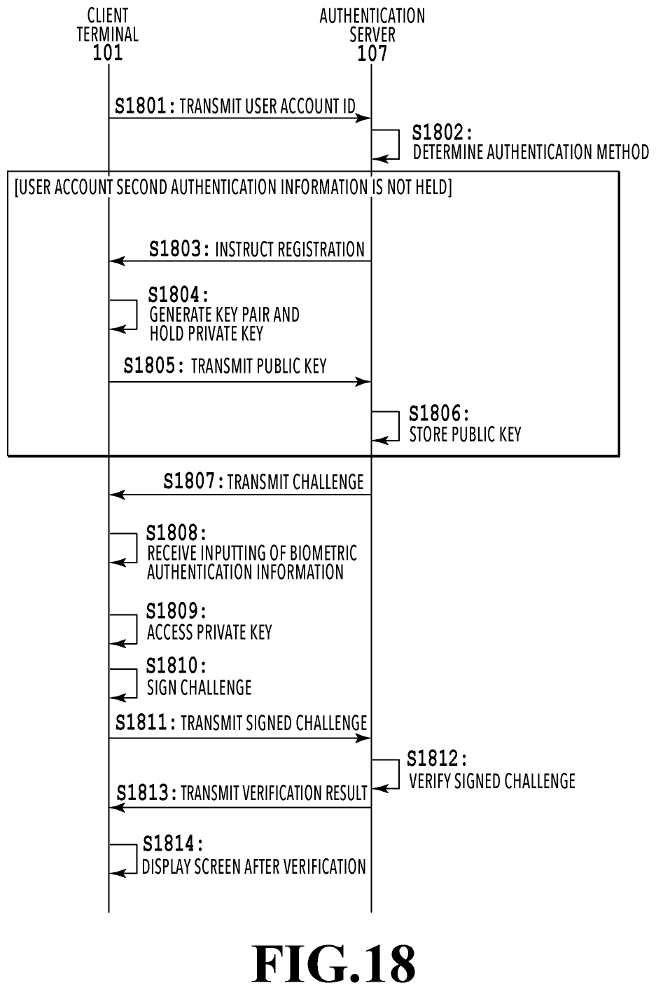

FIG. 18 is a sequence diagram illustrating an example of processing of OAO authentication at the client terminal 101. As illustrated in FIG. 11, OAO authentication is executed at S1000 before processing for inputting a printing job to the remote work service 103 starts at the client terminal 101. Challenge encryption and decryption with a key pair is used in the OAO authentication illustrated in FIG. 18. In addition, biometric authentication at the client terminal 101 is used.

As illustrated in FIG. 18, first at S1801, the client terminal 101 transmits a user account ID that is identification information for identifying a user to the authentication server 107.

Subsequently at S1802, the authentication server 107 determines an authentication method. Then, the authentication server 107 advances the processing to S1803 in a case where no public key corresponding to the user account ID is stored, or advances the processing to S1807 in a case where such a public key is stored.

At S1807, the authentication server 107 transmits a challenge to the client terminal 101.

At S1808, the client terminal 101 receives inputting of biometric authentication information.

At S1809, the client terminal 101 accesses a private key.

At S1810, the client terminal 101 encrypts the challenge received at S1807 by signing with the private key accessed at S1809.

At S1811, the client terminal 101 transmits the challenge signed at S1810 to the authentication server 107.

At S1812, the authentication server 107 verifies the signed challenge by using the public key stored at S1806.

At S1813, the authentication server 107 transmits a verification result to the client terminal 101.

At S1814, the client terminal 101 displays a screen after authentication.

In a case where authentication is successful, a printing job can be registered to the remote work service 103 through a screen for printing job registration at the client terminal 101.

In a case where no public key corresponding to the user account ID is stored at S1802, the processing is advanced to S1803 as described above, and then at S1803, the authentication server 107 transmits a registration instruction to the client terminal 101.

At S1804, the client terminal 101 generates a key pair of a private key and a public key and holds the private key.

At S1805, the client terminal 101 transmits the public key to the authentication server 107.

At S1806, the authentication server 107 stores the public key.

After executed up to S1806, the processing is advanced to S1807. Processing at S1807 and later is processing in a case where the public key corresponding to the user account ID is stored at S1802.

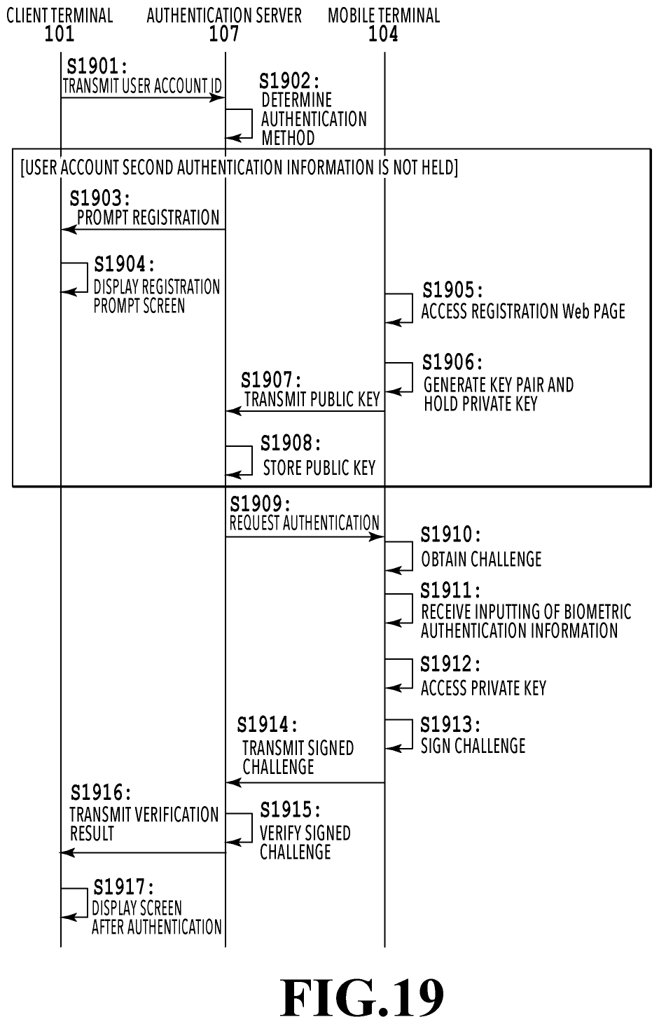

FIG. 19 is a sequence diagram illustrating another example of processing of user authentication (OAO authentication) at the client terminal 101. Challenge encryption and decryption with a key pair is used in the OAO authentication illustrated in FIG. 19. In addition, biometric authentication at the mobile terminal 104 is used.

As illustrated in FIG. 19, first at S1901, the client terminal 101 transmits a user account ID that is identification information for identifying a user to the authentication server 107.

Subsequently at S1902, the authentication server 107 determines authentication method. Then, the authentication server 107 advances the processing to S1903 in a case where no public key corresponding to user identification information is stored, or advances the processing to S1909 in a case where such a public key is stored.

At S1909, the authentication server 107 transmits an authentication request to the mobile terminal 104.

At S1910, the mobile terminal 104 obtains a challenge.

At S1911, the mobile terminal 104 receives inputting of biometric authentication information.

At S1912, the mobile terminal 104 accesses a private key.

At S1913, the mobile terminal 104 encrypts the challenge obtained at S1910 by signing with the private key accessed at S1912.

At S1914, the mobile terminal 104 transmits the signed challenge to the authentication server 107.

At S1915, the authentication server 107 verifies the signed challenge by using the public key stored at S1908.

At S1916, the authentication server 107 transmits a verification result to the client terminal 101.

At S1917, the client terminal 101 displays a screen after authentication.

In a case where authentication is successful, a printing job can be registered to the remote work service 103 through a screen for printing job registration at the client terminal 101.

In a case where no public key corresponding to the user account ID is stored at S1902, the processing is advanced to S1903 as described above, and then at S1903, the authentication server 107 transmits a registration prompt to the client terminal 101.

At S1904, the client terminal 101 displays a registration prompt screen.

At S1905, the mobile terminal 104 accesses a registration WEB page. The user sees the registration prompt screen and operates the mobile terminal 104 accordingly to execute S1905.

At S1906, the mobile terminal 104 generates a key pair of a private key and a public key and holds the private key.

At S1907, the mobile terminal 104 transmits the public key to the authentication server 107.

At S1908, the authentication server 107 stores the public key.

After executed up to S1908, the processing is advanced to S1909. Processing at S1909 and later is processing in a case where the public key corresponding to the user account ID at S1902 is stored.

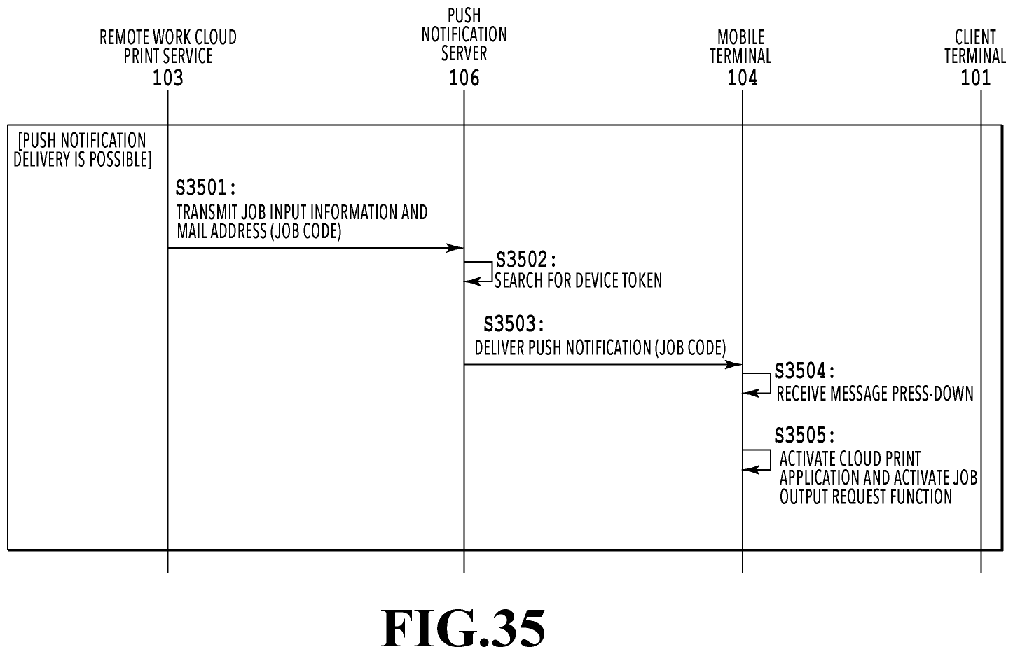

OAO authentication using PUSH notification, which will be described below with reference to FIG. 35 in the third embodiment, may be used as the OAO authentication at the client terminal 101.

### <10. Display and Non-Display Control of Buttons at Mobile Terminal>

A method of controlling display and non-display of buttons at the mobile terminal 104 will be described below with reference to FIGS. 20A, 20B, 21, and 22.

The screen 2010 illustrated in FIG. 20A is a main screen displayed by the application 2000. The screen 2020 illustrated in FIG. 20B is based on image data transferred from the household service 105 to the mobile terminal 104 at S1408 (FIG. 14) or S1505 (FIG. 15) described above. The screen 2020 illustrated in FIG. 20B is displayed on the screen of the mobile terminal 104 at S1410 (FIG. 14) or S1506 (FIG. 15) described above.

An icon and the model name of the image forming apparatus 102 registered to the application 2000 are displayed at an upper part of the screen 2010. In addition, the “remote work cloud print service” button 2011 and a “registration to household cloud print service” button 2012 are disposed on the screen 2010. Further, the “picture print” button 2013, the “document print” button 2014, and the “scan” button 2015 are disposed on the screen 2010. The “registration to household cloud print service” button 2012 may be disposed on another screen not illustrated.

The “remote work cloud print service” button 2011 is a button for activating a function that the mobile terminal 104 transmits a printing job transmission request in the remote work service 103. AOA authentication is executed when the “remote work cloud print service” button 2011 is pressed down. The function is activated and the screen 2020 is displayed when a predetermined condition is satisfied after the AOA authentication.

The “registration to household cloud print service” button 2012 is a button for registering, further to the household service 105, the image forming apparatus 102 registered to the application 2000.

The “picture print” button 2013, the “document print” button 2014, and the “scan” button 2015 are already described, and thus duplicate description thereof is omitted.

An input region 2021 for inputting a job code, an “OK” button 2022, and a “cancel” button 2023 are disposed on the screen 2020. A job code is input to the input region 2021 by the user at S1123 (FIG. 12) and the “OK” button 2022 is pressed down. Then, a printing job transmission request together with the job code input to the input region 2021 is transmitted to the household service 105 at S1125 (FIG. 12). When the “cancel” button 2023 is pressed down by the user, transmission of the printing job transmission request is canceled in advance.

The application 2000 is basically for using the household service 105 from the mobile terminal 104. Thus, the printer ID of the image forming apparatus 102 registered to the application 2000 basically needs to be registered to the household service 105. The “registration to household cloud print service” button 2012 is provided for the registration.

The household service 105 includes a plurality of services. Specifically, the household service 105 has a function to perform printing from, for example, various cloud services (such as Facebook, Google Drive, Dropbox, OneDrive, Box, Evernote, and Google Photos). Thus, although not illustrated, a button for displaying a menu screen (not illustrated) for selecting various cloud services included in the household service 105 may be provided on the screen 2010 so that the menu screen is displayed when the button is pressed down.

In a case where the mobile terminal 104 can perform AOA authentication, the image forming apparatus 102 used in the household service 105 can be designated based on a printer ID associated with an app account ID used in AOA authentication. Thus, in a case where the mobile terminal 104 can perform AOA authentication, the printer ID of the image forming apparatus 102 does not need to be registered to the household service 105 in advance. Accordingly, the “registration to household cloud print service” button 2012 does not need to be disposed on the screen 2010.

In a case where the mobile terminal 104 can perform AOA authentication, the mobile terminal 104 and the image forming apparatus 102 basically can use the remote work service 103. Thus, in a case where the mobile terminal 104 can perform AOA authentication, the “remote work cloud print service” button 2011 can be effectively used. In a case where the mobile terminal 104 cannot perform AOA authentication, the “remote work cloud print service” button 2011 does not need to be disposed.

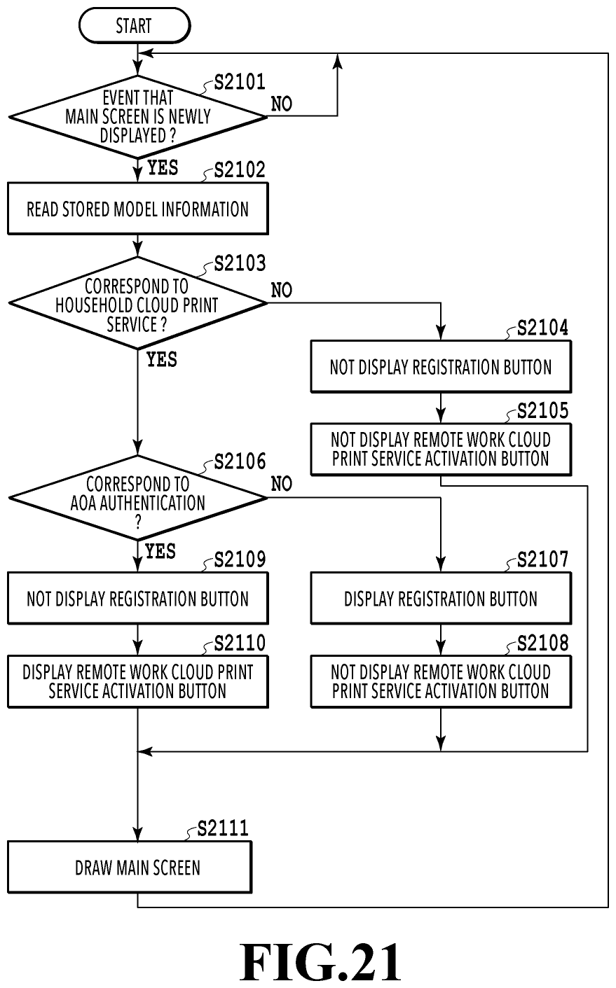

Thus, display and non-display of the “remote work cloud print service” button 2011 and the “registration to household cloud print service” button 2012 are controlled by a method as illustrated in FIG. 21.

As illustrated in FIG. 21, in a case where an event that the main screen of the application 2000 is newly displayed has occurred (YES at S2101), processing is executed from S2102. The event occurs, for example, when the application 2000 is activated to be executed from start.

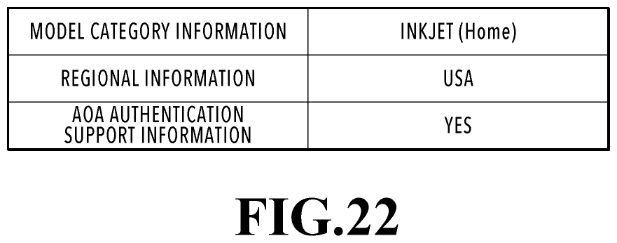

At S2102, the mobile terminal 104 reads stored model information. The model information includes, for example, model category information, regional information, and AOA authentication support information as illustrated in FIG. 22. The model information may additionally include information as illustrated in FIG. 6, which is not illustrated in FIG. 22.

The model information is obtained from the image forming apparatus 102 and stored in the mobile terminal 104 at initial setting performed after installation of the image forming apparatus 102. For example, when firmware of the image forming apparatus 102 is updated, the model information is potentially updated, and thus the model information stored in the mobile terminal 104 is updated as well.

At S2103, the mobile terminal 104 determines whether the image forming apparatus 102 corresponds to the household service 105 based on a model name or a model category included in the model information of the image forming apparatus 102 registered to the application 2000. For example, whether the image forming apparatus 102 is an electrophotographic image forming apparatus or a liquid discharge image forming apparatus is determined based on the model name, and if so, it is determined that the image forming apparatus 102 corresponds to the household service 105. Alternatively, whether the image forming apparatus 102 is an electrophotographic image forming apparatus or a liquid discharge image forming apparatus is determined directly from “model category information” as illustrated in FIG. 21, and if so, it is determined that the image forming apparatus 102 corresponds to the household service 105.

In a case where the determination result at S2103 is NO, the processing is advanced to S2104 to perform setting for non-display of the “registration to household cloud print service” button 2012. Subsequently at S2105, setting for non-display of the “remote work cloud print service” button 2011 is performed.

In a case where the determination result at S2103 is YES, the processing is advanced to S2106 to determine whether the image forming apparatus 102 corresponds to AOA authentication. The determination of whether the image forming apparatus 102 corresponds to AOA authentication is performed based on the AOA authentication support information included in the model information.

In a case where the determination result at S2106 is NO, the processing is advanced to S2107 to perform setting for display of the “registration to household cloud print service” button 2012. Subsequently at S2108, setting for non-display of the “remote work cloud print service” button 2011 is performed.

In a case where the determination result at S2106 is YES, the processing is advanced to S2109 to perform setting for non-display of the “registration to household cloud print service” button 2012. Subsequently at S2110, setting for display of the “remote work cloud print service” button 2011 is performed.

At S2111 following S2105, S2108, or S2110, the main screen is drawn. In the drawing, display and non-display of buttons are controlled in accordance with settings of display and non-display of buttons.

In a case where the application 2000 is upgraded, criteria used for the determination at S2103 and databases in the application potentially change for the same model information.

The “registration to household cloud print service” button 2012 and the “remote work cloud print service” button 2011 are not necessarily displayed on the same screen. For each button, relevant steps need to be executed when a screen on which the button is disposed is drawn. Specifically, S2105, S2108, and S2110 may be omitted for a screen on which the “registration to household cloud print service” button 2012 is disposed but the “remote work cloud print service” button 2011 is not disposed. S2104, S2107, and S2109 may be omitted for a screen on which the “registration to household cloud print service” button 2012 is not disposed but the “remote work cloud print service” button 2011 is disposed.

<11. Processing when “Remote Work Cloud Print Service” Button is Pressed at Mobile Terminal>

The following describes activation processing of a printing job transmission request function at the mobile terminal 104 and sending of a printing job transmission request when the “remote work cloud print service” button 2011 is pressed at the mobile terminal 104.

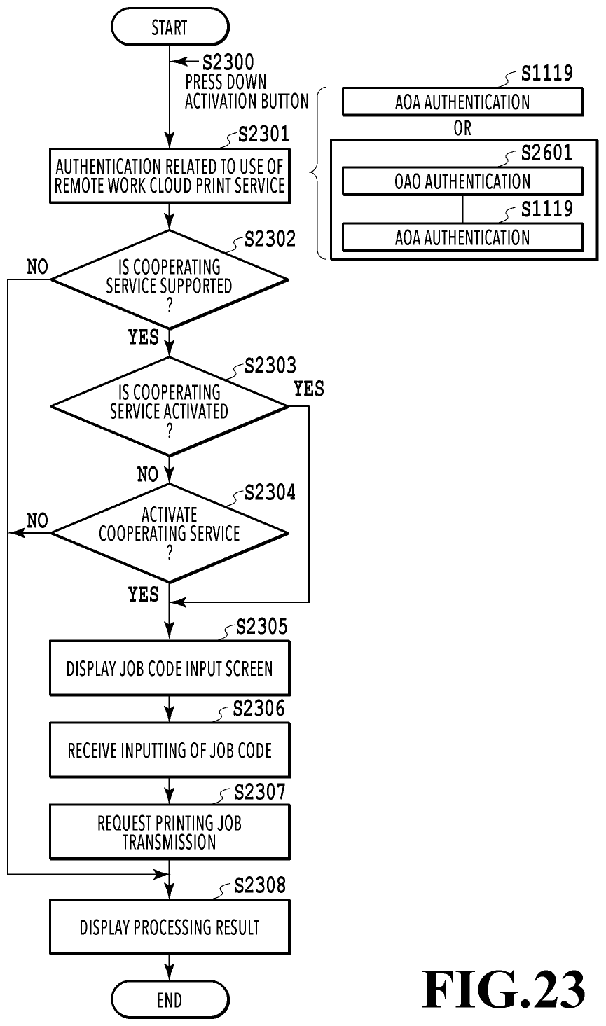

Processing illustrated in FIG. 23 is executed in accordance with, for example, a user instruction through the display unit, the input apparatus, or the like of the mobile terminal 104, or a user instruction received by the application 2000 installed on the mobile terminal 104. It is assumed in the following description that the application 2000 and a browser are used to receive user instructions.

The “remote work cloud print service” button (simplified as “activation button” in FIG. 23) 2011 disposed on the application 2000 is pressed down. Accordingly, at S2301, authentication related to use of the remote work service 103 is executed. Specifically, AOA authentication (S1119) is performed. OAO authentication (S2601) and AOA authentication (S1119) may be both performed, which will be described in a second embodiment. In a case where only AOA authentication is performed, the processing described above with reference to FIGS. 13 to 15 is performed.

In a case where the authentication is successful, processing at S2302 to S2304, which is omitted in the description with reference to FIGS. 13 to 15, is executed, and the screen 2020 for inputting a job code at S2305 is displayed on the mobile terminal 104 in a case where a predetermined condition is satisfied. S2305 corresponds to S1410 illustrated in FIG. 14 or S1506 illustrated in FIG. 15.

At S2302, the authentication control unit 304 of the mobile terminal 104 performs determination as follows. Specifically, it is determined whether the image forming apparatus 102 associated with the application 2000 supports a service related to a printing job transmission system.

The “printing job transmission system” is basically a cooperating cloud print service that performs a series of processing as illustrated in FIGS. 11 and 12. The cooperating cloud print service includes the remote work service 103 and the household service 105. The printing job transmission system is functionally configured such that a printing job input from the client terminal 101 is transmitted to the image forming apparatus 102 in accordance with an instruction from the mobile terminal 104 and the image forming apparatus 102 executes printing based on the printing job.

An exemplary method of the determination at S2302 is as follows, for example. Specifically, the mobile terminal 104 transmits the model information of the image forming apparatus 102 to the household service 105. Then, the mobile terminal 104 receives, as a response, a list of applications, functions, or services that the image forming apparatus 102 supports from the household service 105. In a case where the list received by the mobile terminal 104 includes a service related to the printing job transmission system, the authentication control unit 304 of the mobile terminal 104 determines that the image forming apparatus 102 supports a service related to the printing job transmission system. In this case, the determination result at S2302 is YES, and accordingly, the authentication control unit 304 of the mobile terminal 104 advances the processing to S2303.

The mobile terminal 104 receives the list from the household service 105. In a case where the list includes no service related to the printing job transmission system, the authentication control unit 304 of the mobile terminal 104 determines that the image forming apparatus 102 supports no service related to the printing job transmission system. In this case, the determination result at S2302 is NO, and accordingly, the authentication control unit 304 of the mobile terminal 104 skips S2303 to S2307 and advances the processing to S2308.

At S2303, the authentication control unit 304 of the mobile terminal 104 checks, based on the response received at S2302, whether the service related to the printing job transmission system is activated. In a case where the service related to the printing job transmission system is activated, the service related to the printing job transmission system can be used. Specifically, the authentication control unit 304 of the mobile terminal 104 checks the value of a flag or the like included in the response received at S2302 and indicating whether the service related to the printing job transmission system is activated. In a case where the value indicates “activated”, the determination result at S2302 is YES, and accordingly, the authentication control unit 304 of the mobile terminal 104 advances the processing to S2305.

In a case where the value indicates “not activated”, the determination result at S2302 is NO, and accordingly, the authentication control unit 304 of the mobile terminal 104 advances the processing to S2304.

Examples of reasons why the service related to the printing job transmission system is not activated are as follows:
the service related to the printing job transmission system is set to inactivated in the household service 105
no contract for using the service related to the printing job transmission system is signed

Thus, at S2304, for example,
processing for setting the service related to the printing job transmission system to activated at the household service 105
processing for signing a contract for using the service related to the printing job transmission system
   is executed.

The authentication control unit 304 of the mobile terminal 104 determines YES and advances the processing to S2305 in a case where activation is successful at S2304, or determines NO and advances the processing to S2308 in a case where activation is unsuccessful at S2304.

At S2305, the UI control unit 306 of the mobile terminal 104 presents the screen 2020 illustrated in FIG. 20B through the browser. Specifically, the mobile terminal 104 obtains data of the screen 2020 by accessing the household service 105 and presents the screen 2020 to the user based on the data.

The screen 2020 illustrated in FIG. 20B is a screen that receives inputting of a job code corresponding to a desired printing job from the user. The input region 2021 is a region that receives inputting of a job code for identifying a printing job from the user. The button 2022 is a button for receiving, from the user, an instruction related to execution of printing based on the printing job based on the job code input to the input region 2021. The button 2023 is a button for receiving, from the user, an instruction related to cancellation of printing based on the printing job based on the input job code.

At S2306, the printing job management unit 302 of the mobile terminal 104 receives inputting of a job code corresponding to a desired printing job from the user. The job code input to the input region 2021 is, for example, a job code notified by the remote work service 103 in advance. The job code is used by the household service 105 to specify a printing job. Thus, processing related to reception of job code inputting does not necessarily need to be executed. As a specific example, the mobile terminal 104 may perform authentication of the user by receiving inputting related to authentication from the user and may receive, from the user, designation of a desired printing job from a list of printing jobs associated with the user. Alternatively, the mobile terminal 104 may perform authentication of the mobile terminal 104 by receiving inputting related to authentication from the user and may receive, from the user, designation of a desired printing job from a list of printing jobs associated with the mobile terminal 104. The mobile terminal 104 may perform authentication of the mobile terminal 104 by receiving inputting related to authentication from the user and may receive, for example the user, designation of a desired printing job from a list of printing jobs associated with the image forming apparatus 102 associated with the mobile terminal 104.

At S2307, the printing job management unit 302 of the mobile terminal 104 transmits the job code input at S2306 to the household service 105 and requests the household service 105 for printing job transmission. Specifically, when the button 2022 is pressed down, the mobile terminal 104 transmits information input to the input region 2021 to the household service 105. Accordingly, the household service 105 is requested for printing job transmission. When the button 2023 is pressed down, a printing job specified by the job code is deleted by transmitting information input to the input region 2021 to the household service 105. Specifically, processing at S2501 to S2507 is executed.

At S2308, the printing job management unit 302 of the mobile terminal 104 presents results of a series of processing to the user. Specifically, in a case where it is determined at S2302 that the image forming apparatus 102 supports no service related to the printing job transmission system, this information is presented to the user. In a case where no service related to the printing job transmission system is activated at S2304, this information is presented to the user. In a case where a printing job is normally transmitted to the image forming apparatus 102 after execution of S2307, information of the normal completion of the transmission may be presented.

S2307 corresponds to S1125 illustrated in FIG. 12, and thereafter, the processing at S1127 and later is executed.

<12. Processing of Printing Job Deletion Based on Instruction from Client Terminal>

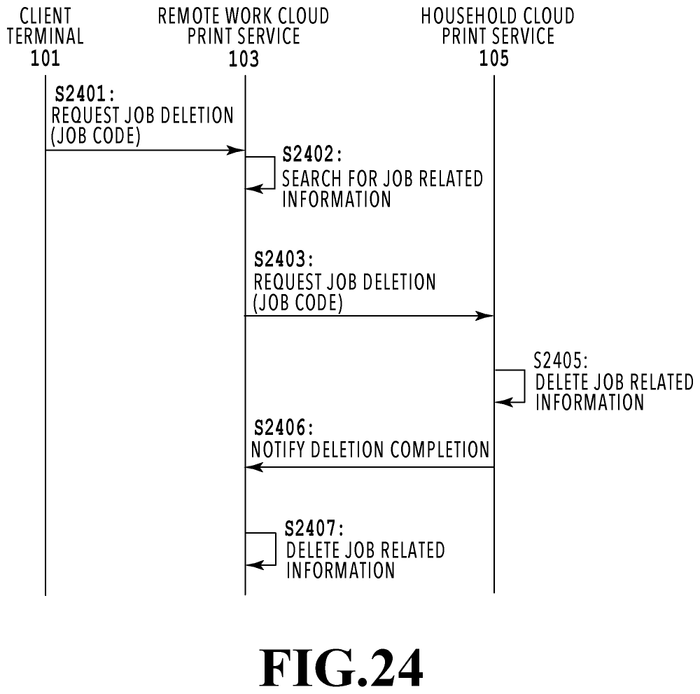

Processing of deleting a printing job in accordance with an instruction from the client terminal will be described below with reference to FIG. 24. The processing illustrated in FIG. 24 is executed, for example, in a case where the button 1723 on the screen 1700 is pressed down. The processing illustrated in FIG. 24 may be executed in a case where the expire date illustrated in FIG. 4B has elapsed. The processing illustrated in FIG. 24 may be executed in a case where a printing job execution result indicating that the remote work service 103 has successfully performed printing at S1143 is received.

As illustrated in FIG. 24, at S2401, the client terminal 101 transmits a printing job deletion request to the remote work service 103 in accordance with an instruction from the user. The job code of a printing job to be deleted is attached to the deletion request.

As a specific example, the client terminal 101 may present a screen related to the printing job deletion request to the user through a browser or the like and may receive designation of information (for example, job code) related to a deletion target printing job through the screen.

As another example, the client terminal 101 may present a list of registered printing jobs to the user and may receive designation of a deletion target printing job in the list from the user. In this case, the client terminal 101 may obtain information related to registered printing jobs from, for example, the remote work service 103 and may produce the above-described list based on the information. The screen may be presented to the user, for example, in a case where the item 1712 on the screen 1710 is designated.

At S2402, the printing job management unit 302 of the remote work service 103 searches the storage unit 305 for printing-job related information (refer to FIG. 5A) corresponding to the printing job of the received deletion request, and advances the processing to S2403. In a case where the search is unsuccessful, the processing ends.

At S2403, the printing job management unit 302 of the remote work service 103 transmits, to the household service 105, a printing job deletion request to which the job code corresponding to the deletion target printing job is attached.

At S2405, the printing job management unit 302 of the household service 105 searches the storage unit 305 for printing-job related information (refer to FIG. 5B) by using the job code attached to the deletion request received at S2403 as a key, and deletes the printing-job related information. In this case, the printing job management unit 302 of the household service 105 may store information related to the target printing job as a history in a predetermined storage region. As a specific example, the printing job management unit 302 of the household service 105 may set a relevant flag for not responding to a printing job transmission request from the mobile terminal 104. A copy of information used as a history in the printing-job related information may be stored in a predetermined storage region (for example, the storage unit 305).

At S2406, the printing job management unit 302 of the household service 105 notifies the remote work service 103 of completion of the printing-job related information deletion.

At S2407, the printing job management unit 302 of the remote work service 103 deletes data corresponding to the printing job designated as the deletion target. Specifically, the printing-job related information searched at S2402 is deleted. The printing-job related information includes printing job data corresponding to the printing job as illustrated in FIGS. 5A and 5B. In this case, the printing job management unit 302 of the remote work service 103 may store information related to the target printing job as a history in a predetermined storage region. As a specific example, the printing job management unit 302 of the remote work service 103 refers to printing-job related information (refer to FIG. 5A) corresponding to the deletion target printing job. Then, the printing job management unit 302 of the remote work service 103 may store, in a predetermined storage region (for example, the storage unit 305), a copy of information used as a history in the referred printing-job related information.

<13. Processing of Printing Job Deletion Based on Instruction from Mobile Terminal>

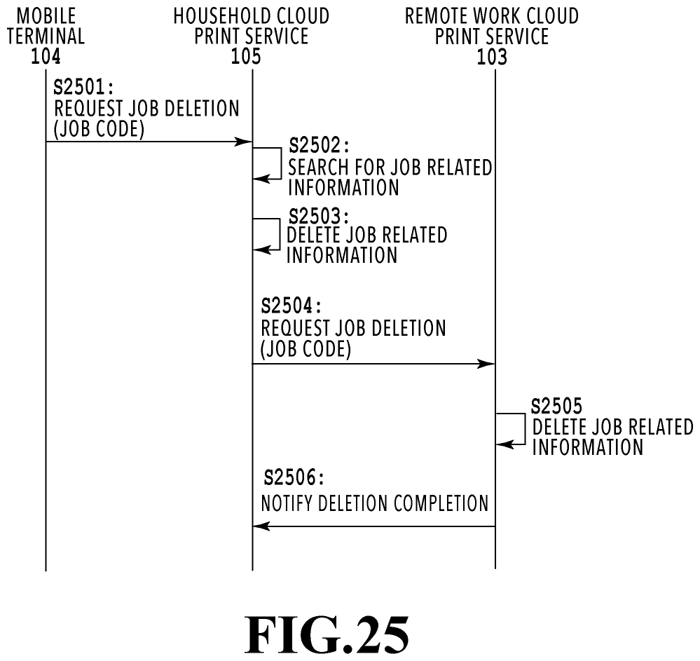

Processing of deleting a printing job in accordance with an instruction from the mobile terminal will be described below with reference to FIG. 25.

At S2501, the mobile terminal 104 transmits a printing job deletion request to the household service 105 in accordance with an instruction from the user.

As a specific example, the mobile terminal 104 may present a screen related to the printing job deletion request to the user through a browser or the like and may receive designation of information (for example, job code) related to a deletion target printing job through the screen.

As another example, the mobile terminal 104 may present a list of registered printing jobs to the user and may receive designation of a deletion target printing job in the list from the user. In this case, the mobile terminal 104 may obtain information related to registered printing jobs from, for example, the household service 105 and may produce the above-described list based on the information.

At S2502, the printing job management unit 302 of the household service 105 searches the storage unit 305 for printing-job related information (refer to FIG. 5B) corresponding to a printing job specified by a job code attached to the deletion request. In a case where the search is unsuccessful, the processing ends.

At S2503, the printing job management unit 302 of the household service 105 deletes the printing-job related information (refer to FIG. 5B) searched at S2502. In this case, the printing job management unit 302 of the household service 105 may store information related to the target printing job as a history in a predetermined storage region. As a specific example, the printing job management unit 302 of the household service 105 may set a relevant flag for not responding to a printing request from the mobile terminal 104. A copy of information used as a history in the printing-job related information may be stored in a predetermined storage region (for example, the storage unit 305).

At S2504, the printing job management unit 302 of the household service 105 transmits, to the remote work service 103, a printing job deletion request to which the job code corresponding to the deletion target printing job is attached.

At S2505, the printing job management unit 302 of the remote work service 103 deletes printing-job related information (refer to FIG. 5A) specified by the job code attached to the printing job deletion request received at S2504. In this case, the printing job management unit 302 of the remote work service 103 may store information related to the target printing job as a history in a predetermined storage region. As a specific example, the printing job management unit 302 of the remote work service 103 refers to printing-job related information (refer to FIG. 5A) corresponding to the deletion target printing job. Then, the printing job management unit 302 of the remote work service 103 may store, in a predetermined storage region (for example, the storage unit 305), a copy of information used as a history in the referred printing-job related information.

At S2506, the printing job management unit 302 of the remote work service 103 notifies the household service 105 of completion of the printing job deletion.

In the first embodiment, the combined configuration of the client terminal 101, the image forming apparatus 102, the remote work service 103, the mobile terminal 104, and the household service 105 is used. According to the first embodiment, with such a configuration, it is possible to improve usability and security related to use of the remote work service 103.

### Second Embodiment

The second embodiment is basically the same as the first embodiment. The second embodiment is different from the first embodiment in that authentication performed at the mobile terminal 104 is AOA authentication only in Embodiment 1 but is OAO authentication and AOA authentication in the second embodiment.

### <1. System Configuration>

A system configuration according to the second embodiment is the same as illustrated in FIG. 1 according to the first embodiment.

### <2. Overall Processing Flow>

The operations and screens of the first embodiment, which are described above in the first embodiment are basically the same in the second embodiment, and thus any duplicate describe thereof is omitted.

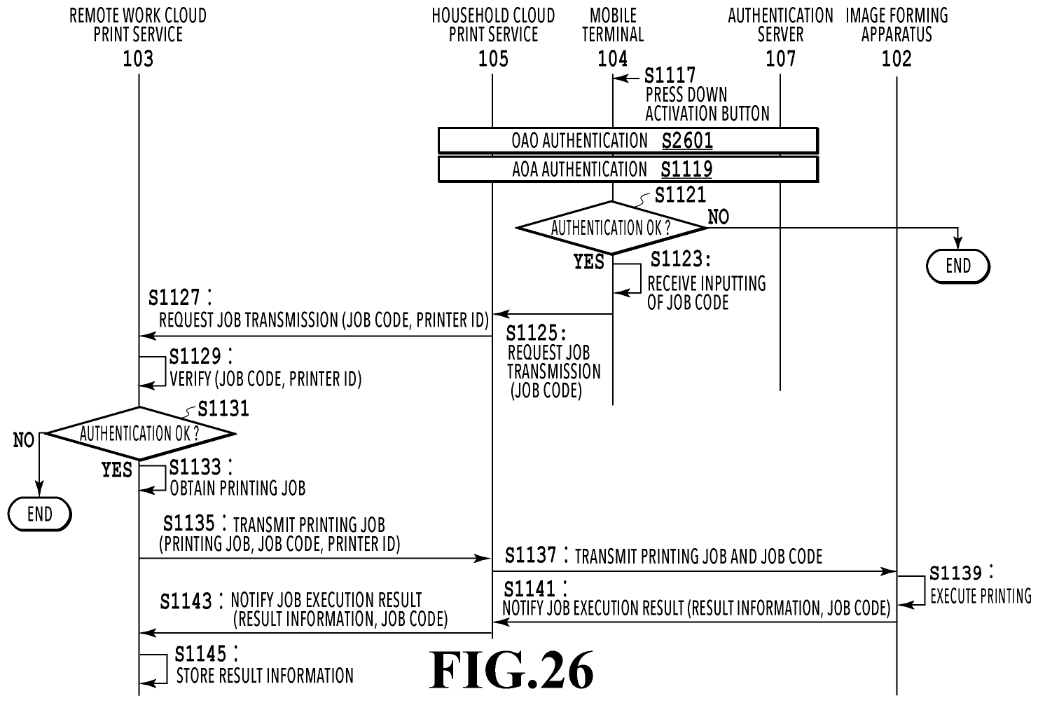

The overall flow of processing in the first embodiment is as illustrated in FIGS. 11 and 12. In the second embodiment, the processing illustrated in FIG. 12 is replaced with processing illustrated in FIG. 26. Accordingly, the overall flow of processing according to the second embodiment is as illustrated in FIGS. 11 and 26.

As clearly understood from comparison between FIGS. 12 and 26, the second embodiment is different from the first embodiment in that OAO authentication (S2601) is added in front of AOA authentication (S1119). OAO authentication (S2601) may be added after AOA authentication (S1119).

### <3. OAO Authentication at Mobile Terminal>

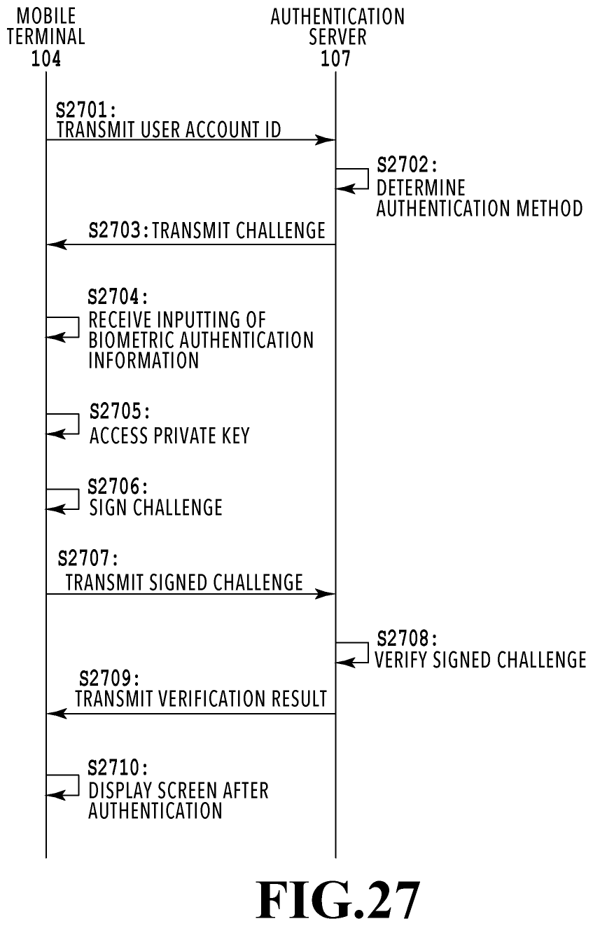

Details of OAO authentication (S2601) illustrated in FIG. 26 will be described below with reference to FIG. 27.

Processing illustrated in FIG. 27 is executed in accordance with, for example, a user instruction through a display apparatus, an input apparatus, or the like of the mobile terminal 104, or a user instruction received by an application installed on the mobile terminal 104. It is assumed in the following description that the application 2000 is used to receive user instructions.

Specifically, the application 2000 accesses the URL of “http://companyA.com” corresponding to the remote work service 103. Then, the top screen of a UI related to use of the remote work service 103, which is downloaded from the URL by the application 2000 is displayed.

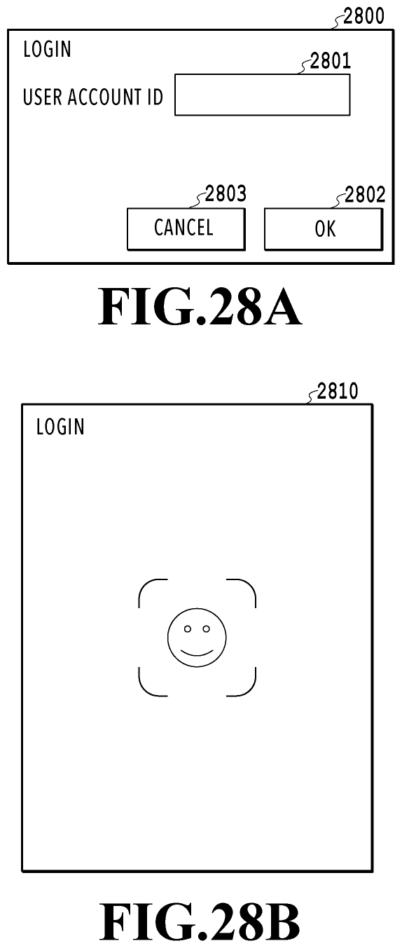

For example, a screen 2800 illustrated in FIG. 28A is an example of the top screen. The screen 2800 is a screen that receives inputting of information related to user authentication.

An input region 2801 is a region that receives, from a user, inputting of a user account ID for identifying the user.

A button 2802 is a button for receiving, from the user, an instruction related to determination of an authentication method for the user based on the user account ID input to the input region 2801. A button 2803 is a button for receiving an instruction related to termination of use of the remote work service 103 from the user.

At S2701, when a user account ID is input to the input region 2801 on the screen 2800 and the button 2802 is pressed down, the mobile terminal 104 transmits the user account ID to the authentication server 107.

At S2702, the authentication control unit 304 of the authentication server 107 executes, based on the user account ID transmitted from the mobile terminal 104, processing related to determination of an authentication method for a user corresponding to the user account ID. Specifically, it is checked whether account second authentication information of the user corresponding to the user account ID is stored in the storage unit 305 of the authentication server 107. In a case where the account second authentication information corresponding to the user account ID is stored, authentication processing is executed by an authentication method (for example, a public key encryption scheme) using the account second authentication information. In a case where no account second authentication information corresponding to the user account ID is stored, authentication processing is executed by an authentication method (for example, a password scheme) using account authentication information. As another method, the mobile terminal 104 of the user may be specified based on a phone number or a mail address so that authentication processing is executed by a one-time password scheme, or authentication processing may be executed by using both the password scheme and the one-time password scheme. Moreover, the account second authentication information may be registered. In the second embodiment, since the account second authentication information is set, it is determined to execute authentication by using an authentication method (for example, the public key encryption scheme) with the account second authentication information.

At S2703, the authentication control unit 304 of the authentication server 107 transmits authentication character string data (for example, challenge) to the mobile terminal 104.

At S2704, based on reception of the challenge at S2703, the UI control unit 306 of the mobile terminal 104 presents a screen 2810 illustrated in FIG. 28B and becomes ready to receive inputting of information related to authentication by the user. The screen 2810 is displayed on the mobile terminal 104, for example, through the application 2000.

The screen 2810 illustrated in FIG. 28B is a screen that receives inputting of information related to user authentication. The screen 2810 notifies the user of the necessity of biometric authentication (for example, fingerprint authentication or face authentication). The biometric authentication is needed to access highly confidential information on the mobile terminal 104, and in the second embodiment, is needed to access the user private key stored in the storage unit 305 of the mobile terminal 104.

At S2705, in a case where the biometric authentication by the user is successful, the authentication control unit 304 of the mobile terminal 104 accesses the private key stored in the storage unit 305 of the mobile terminal 104.

At S2706, the authentication control unit 304 of the mobile terminal 104 signs the authentication character string data received from the authentication server 107 by using the private key stored in the storage unit 305 of the mobile terminal 104 and accessed at S2705.

At S2707, the authentication control unit 304 of the mobile terminal 104 transmits the authentication character string data (for example, signed challenge) signed at S2706 to the authentication server 107.

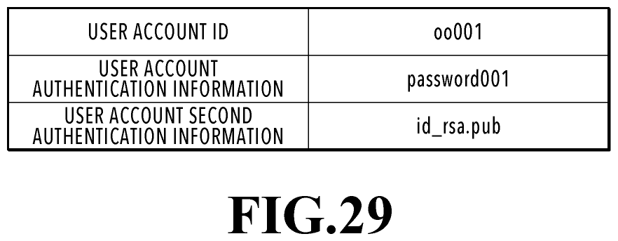

At S2708, the authentication control unit 304 of the authentication server 107 verifies the authentication character string data (for example, signed challenge) received from the mobile terminal 104 by using a public key. The public key is stored in in the storage unit 305 of the authentication server 107 in association with the user account ID as illustrated in FIG. 29. Specifically, it is determined that authentication is successful in a case where the received authentication character string data (for example, signed challenge) can be decrypted by using the public key. It is determined that authentication is unsuccessful in a case where the received authentication character string data (for example, signed challenge) cannot be decrypted by using the public key. In this case, the authentication control unit 304 of the authentication server 107 may request a predetermined authentication service for authentication of the user.

At S2709, based on the verification of the authentication character string data (for example, signed challenge) at S2708, the authentication control unit 304 of the authentication server 107 transmits the authentication result to the mobile terminal 104. In the second embodiment, it is assumed that the verification of the authentication character string data (for example, signed challenge) is successful and the user authentication is successful.

At S2710, the UI control unit 306 of the mobile terminal 104 presents the screen 2020 illustrated in FIG. 20B through the application 2000. Specifically, the mobile terminal 104 obtains data of the screen 2020 by accessing the remote work service 103 and presents the screen 2020 to the user based on the data. In the second embodiment, the screen 2020 is presented as a screen in a case where the verification of the authentication character string data (for example, signed challenge) is successful, but the screen 2800 is presented in a case where the verification of the authentication character string data (for example, signed challenge) is unsuccessful. In this case, the screen 2800 is presented with a message indicating that authentication is necessary again because authentication is unsuccessful.

An authentication server that performs OAO authentication may store a user account ID in association with a printer ID. Specifically, for example, the authentication server may hold the information illustrated in FIG. 8 in which the app account ID and the app account authentication information are replaced with a user account ID and user account authentication information. The same processing as the processing related to AOA authentication and illustrated in FIGS. 13 to 15 may be performed for OAO authentication. In the processing, the app account ID and the app account authentication information included in the authentication information may be replaced with the user account ID and the user account authentication information. Accordingly, even if AOA authentication (S1119) at the mobile terminal 104 is omitted in the processing illustrated in FIG. 26, a printer ID can be obtained by using the user account ID used in OAO authentication as a key. Thus, OAO authentication (S2601) may be used in place of AOA authentication (S1119).

In the above-described example, the user inputs the user account ID to the input region 2801 provided on the screen 2800 illustrated in FIG. 28A, but this is not a limiting example. For example, the user account ID may be pushed to the mobile terminal 104 from the remote work service 103, and the screen 2800 may be displayed in a state in which the user account ID is input in the input region 2801. Moreover, press-down of the button 2802 may be automated while display of the screen 2800 is omitted. With this configuration, the user can omit work of inputting the user account ID.

### Third Embodiment

The third embodiment is basically the same as the first embodiment. In the first embodiment, the user inputs a job code to the mobile terminal 104. However, in the third embodiment, a job code is pushed to the mobile terminal 104 from the remote work service 103. Thus, in the third embodiment, the user does not need to input a job code to the mobile terminal 104.

### <1. System Configuration>

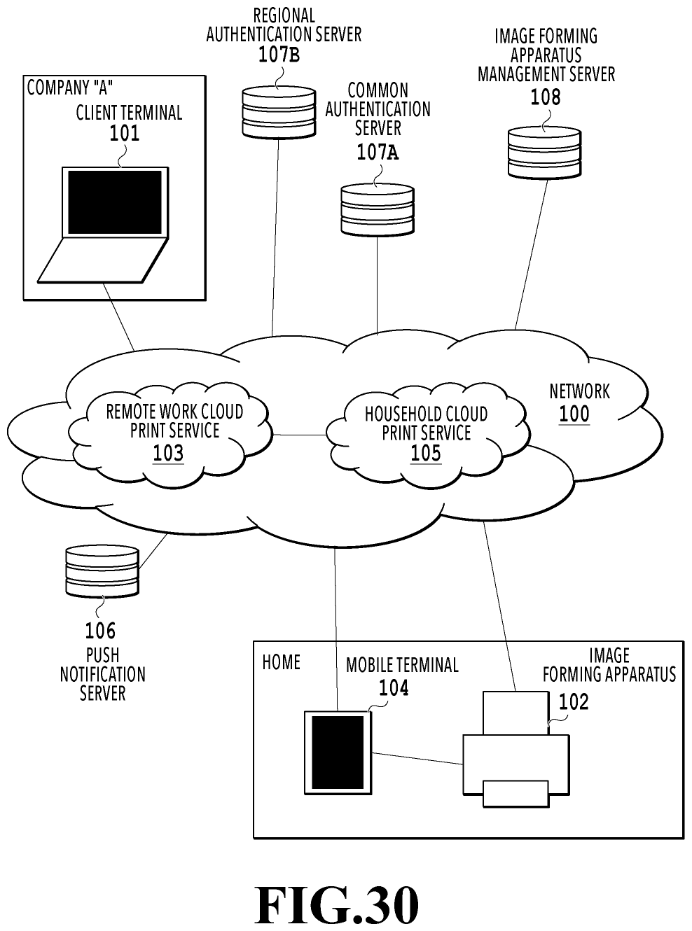

A system configuration according to the third embodiment is illustrated in FIG. 30. As clearly understood from comparison between FIG. 1, which illustrates the system configuration according to the first embodiment, and FIG. 30, the system configuration of the third embodiment is established by adding a push notification server 106 to the system configuration of the first embodiment. As described later, the remote work service 103 pushes a job code to the mobile terminal 104 through the push notification server 106.

### <2. Overall Processing Flow>

The operations and screens of the first embodiment are basically are the same in the third embodiment as well, and thus duplicate description thereof is omitted.

### <3. Registration Processing for Push Notification>

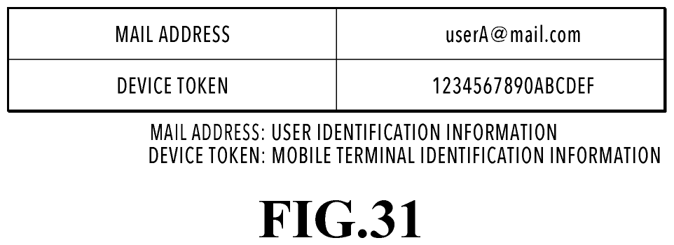

The printing job management unit 302 of the push notification server 106 obtains information related to push notification delivery from another apparatus (for example, the remote work service 103) and stores the information in a predetermined storage region. As illustrated in FIG. 31, the information includes user identification information and mobile terminal identification information. In the example illustrated in FIG. 31, a mail address of the user is used as the user identification information, and a device token of the mobile terminal 104 is used as the mobile terminal identification information. The device token is used as identification information of a notification target device in a push notification service. The push notification service is, for example, Apple push notification service or Firebase cloud messaging.

The user identification information is not particularly limited but may be any information with which the user can be specified, and may be set to an identifier such as such as a user account ID. Information set as the mobile terminal identification information is not limited to a particular type but may be any information with which a user device can be specified, and may be set to an identifier such as a device ID. The mobile terminal identification information may be related with an application used to issue identification information of the mobile terminal. In this case, the mobile terminal identification information is different for each application installed on the mobile terminal 104. For example, the device identification information illustrated in FIG. 31 may be issued by the application 2000 installed on the mobile terminal 104 and may be related with the application 2000. A plurality of pieces of mobile terminal identification information may be set for one user. In this case, the pieces of mobile terminal identification information are allocated to respective mobile terminals 104 owned by the user.

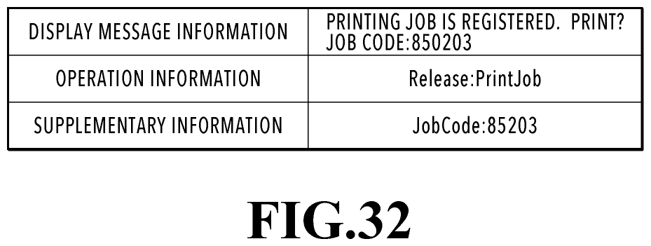

The printing job management unit 302 of the push notification server 106 receives a push notification delivery instruction from the remote work service 103 and transmits a push notification to the mobile terminal 104 in accordance with the instruction. The push notification includes, for example, display message information, operation information, and supplementary information as illustrated in FIG. 32.

The “display message information” is information related to a message displayed on the mobile terminal 104 when the push notification is received by the mobile terminal 104, and includes, for example, a code for displaying a message of which the user is to be notified. In the example illustrated in FIG. 32, “Printing job is registered. Print? Job code: 850203” is set as the display message information.

The “operation information” is information related to operation executed when the push notification is received by the mobile terminal 104, and may be set to, for example, information related to operation that is executable by an application associated with the push notification. In the example illustrated in FIG. 32, “Release: PrintJob” is set as the operation information. In this example, the operation information designates that the mobile terminal 104 performs operation to transmit a printing job transmission request to the household service 105 when having received the push notification. Information set as the operation information only needs to be of a type with which it is possible to specify operation that is executable by an application associated with the push notification. Thus, an identifier such as an operation ID may be set as the operation information.

The “supplementary information” is information that the mobile terminal 104 can refer when executing the operation set in the “operation information”. The “supplementary information” may be set to, for example, information that the application associated with the push notification refers when executing the operation set in the “operation information”. In the example illustrated in FIG. 32, “JobCode: 850203” is set as the supplementary information. In this example, the supplementary information designates that “850203” is attached as a job code to a printing job transmission request.

The communication unit 303 of the push notification server 106 performs transmission and reception of various kinds of data with other apparatuses (for example, the remote work service 103 and the mobile terminal 104). For example, the communication unit 303 of the push notification server 106 may receive user identification information and mobile terminal identification information from the remote work service 103. The communication unit 303 of the push notification server 106 may receive a push notification delivery instruction from the remote work service 103 and may transmit a push notification to the mobile terminal 104 in accordance with the push notification delivery instruction.

The authentication control unit 304 of the push notification server 106 executes various kinds of processing related to authentication for communication with another apparatus. The authentication control unit 304 of the push notification server 106 may store received user information in a predetermined storage region (for example, the storage unit 305) in accordance with an instruction from the remote work service 103. As another example, the authentication control unit 304 of the push notification server 106 may manage authentication information in cooperation with an external authentication service.

The storage unit 305 of the push notification server 106 stores various kinds of data. For example, the storage unit 305 of the push notification server 106 may store various kinds of data in accordance with requests from the printing job management unit 302 and the authentication control unit 304.

The UI control unit 306 of the push notification server 106 executes, in accordance with a request from an administrator, processing related to outputting of a UI for achieving reception of user identification information and mobile terminal identification information and presentation of a push notification to the user. As a specific example, the UI control unit 306 of the push notification server 106 may generate a push notification delivery management screen in accordance with a request from a management terminal (not illustrated). Then, the UI control unit 306 of the push notification server 106 may transmit the screen (or data related to outputting of the screen) to the management terminal through the communication unit 303. Accordingly, the above-described screen generated by the UI control unit 306 of the push notification server 106 is presented to the administrator through the above-described management terminal.

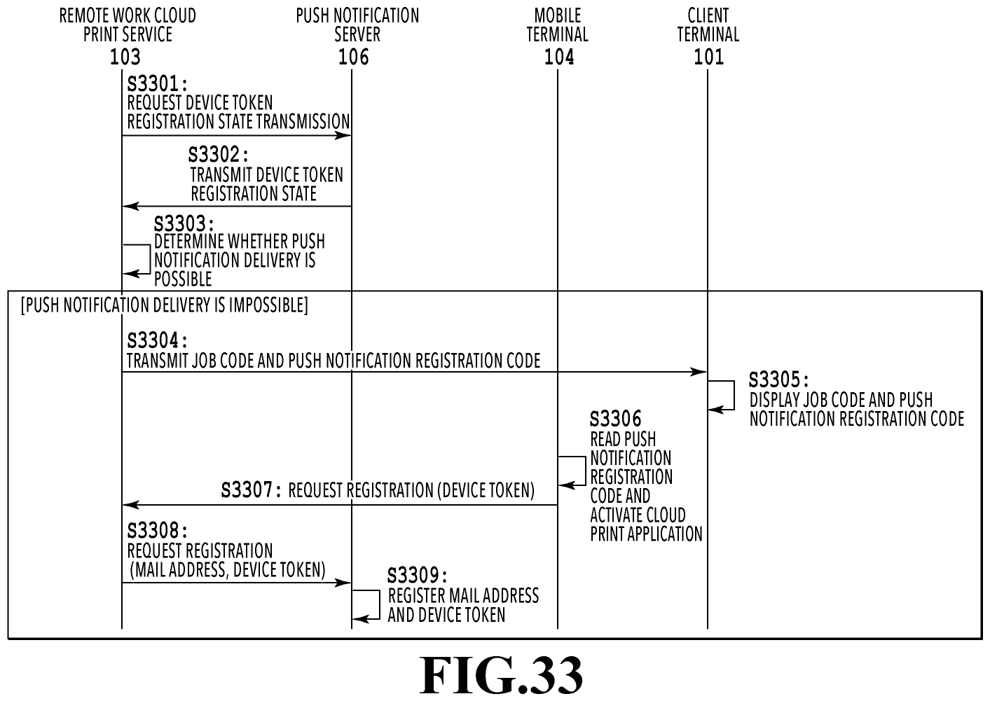

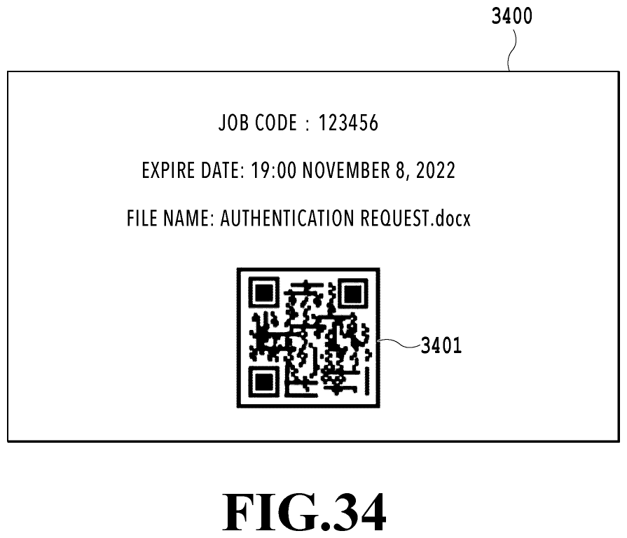

An example of push notification registration processing will be described below with reference to FIGS. 33 and 34. The remote work service 103, the push notification server 106, the mobile terminal 104, and the client terminal 101 are illustrated in FIG. 33. Among them, the input side service apparatus that is an information processing apparatus on which a server for providing the remote work service 103 is mounted functions as a notification source apparatus, and the mobile terminal 104 functions as a notification destination terminal. The remote work service 103 requests the push notification server 106 for a push notification through the input side service apparatus as the notification source apparatus. Then, the push notification server 106 transmits a push notification to the mobile terminal 104 as the notification destination terminal in accordance with the request. As preparation for this, data as illustrated in FIG. 31 is registered to the push notification server 106 by the method illustrated in FIG. 33. In the registration, the client terminal 101 functions as an intermediary terminal. In the registration, the remote work service 103, the push notification server 106, the mobile terminal 104, and the client terminal 101 illustrated in FIG. 33 function as a registration system.

As illustrated in FIG. 33, at S3301, the printing job management unit 302 of the remote work service 103 requests the push notification server 106 to transmit information indicating whether the device token of the mobile terminal 104 of a user having registered a printing job is registered.

At S3302, as a response to the request at S3301, the printing job management unit 302 of the push notification server 106 transmits, to the remote work service 103, information indicating whether the device token of the mobile terminal 104 of the user is registered.

As another example of a method for determining whether it is possible to transmit a push notification to the mobile terminal 104 of the user having registered the printing job, the remote work service 103 may hold a setting value of the determination. In this case, without communication with the push notification server 106, the remote work service 103 can determine whether it is possible to transmit a push notification to the mobile terminal 104 of the user.

At S3303, the printing job management unit 302 of the remote work service 103 determines whether it is possible to deliver a push notification to the mobile terminal 104 of the user. For the determination, the printing job management unit 302 of the remote work service 103 uses the information indicating whether the device token of the mobile terminal 104 of the user is registered, which is received at S3302. In a case where it is determined that the device token is not registered, the processing is advanced to S3304.

At S3304, the remote work service 103 transmits a push notification registration code display request to the client terminal 101. A job code applied to the printing job registered by the user and a push notification registration code are attached to the push notification registration code display request.

At S3305, the UI control unit 306 of the client terminal 101 displays a screen 3400 illustrated in FIG. 34. Specifically, although not illustrated, the client terminal 101 obtains basic data of the screen 3400 by accessing the remote work service 103. Then, the client terminal 101 presents the screen 3400 to the user based on the basic data, and the job code and the push notification registration code that are received at S3304. However, the remote work service 103 may transmit the basic data to the client terminal 101 at S3304. In this case, at S3305, the client terminal 101 presents the screen 3400 to the user based on the basic data, the job code, and the push notification registration code that are received at S3304.

The screen 3400 illustrated in FIG. 34 is an example of a screen related to notification of the job code and presented to the user by the client terminal 101 at S3305. A QR code (registered trademark) 3401 in which the push notification registration code is embedded is presented on the screen 3400 in addition to the contents of the screen 1730 illustrated in FIG. 17D. The screen 3400 may be presented, for example, through a medium such as a mail. Specifically, a mail may be sent to a mail address of the user with the screen 3400 included in the body of the mail. The screen 3400 may be displayed even in a case where the printing job management unit 302 of the remote work service 103 has determined that the device token for push notification delivery is registered at S3303. In this manner, a terminal different from any registered mobile terminal 104 can be registered as a push notification delivery target mobile terminal.

In a case where registration for push notification is independently performed in advance, the job code does not need to be transmitted at S3304 and no information related to the job code is included in the screen illustrated in FIG. 34.

At S3306, the mobile terminal 104 reads the QR code (registered trademark) 3401 included in the screen 3400 displayed on a display unit of the client terminal 101 by using the image capturing apparatus 208 of the mobile terminal 104. The mobile terminal 104 extracts the push notification registration code embedded in the QR code (registered trademark) 3401 and activates the application 2000. Specifically, a URL scheme for specifying and activating the application 2000 is included in the push notification registration code, and the mobile terminal 104 having read the URL scheme activates the application 2000. The URL scheme includes a character string for executing a push notification registration function and can execute the push notification registration function together with activation of the application 2000. After having read the push notification registration code, the mobile terminal 104 may activate the application 2000 through a browser instead of directly activating the application 2000. In this case, the push notification registration code includes the URL of a page to be accessed by the browser. The browser may display explanation related to push notification registration and include a URL link to an application store for downloading the application 2000. Such processing is effective, for example, in a case where no application 2000 is installed on the mobile terminal 104. The browser may include a URL scheme for activating the application 2000.

At S3307, the mobile terminal 104 executes the push notification registration function. Specifically, the printing job management unit 302 of the mobile terminal 104 obtains a device token that is a unique identifier for uniquely specifying the mobile terminal 104. Then, a registration request to which the device token is attached is transmitted to the remote work service 103. The device token may be obtained by the communication unit 303 of the mobile terminal 104 through communication with the push notification service (not illustrated). As another example, in a case where an effective device token is already stored in the storage unit 305 of the mobile terminal 104, the device token may be used. At execution of S3307, S1000 may be executed as authentication processing of the remote work service 103.

Based on the registration request received at S3307, the remote work service 103 transmits the registration request to the push notification server 106 at S3308. The mail address of the user and the device token attached to the registration request received at S3308 are attached to the registration request transmitted at S3308.

At S3309, the printing job management unit 302 of the push notification server 106 stores the mail address and the device token attached to the registration request received at S3308 in the storage unit 305 of the push notification server 106 in association with each other. Accordingly, pre-registration for push notification is completed.

The registration processing illustrated in FIG. 33 may be performed before push notification is actually performed or may be performed when the first push notification is performed as described later.

### <4. Push Notification of Job Code to Mobile Terminal>

The following describes a case where processing is started from S3301 in FIG. 33 each time a job code is pushed to the mobile terminal 104. In this case, in a case where the first push notification is performed, the processing illustrated in FIG. 35 is executed after all processing illustrated in FIG. 33 is executed. In a case where the second push notification or later is performed, the processing illustrated in FIG. 35 is executed after the processing at S3301 to S3303 illustrated in FIG. 33 is executed. However, in a case where it is determined that push notification delivery is possible at S3303, this information may be held as a flag and S3301 and S3302 may be omitted thereafter.

As illustrated in FIG. 35, at S3501, the printing job management unit 302 of the remote work service 103 transmits a push notification request to the push notification server 106. Information included in a push notification and user identification information for specifying a user having registered a printing job are attached to the push notification request. The “information included in a push notification” is “display message information”, “operation information”, and “supplementary information” described above with reference to FIG. 32. The “user identification information” is, for example, a mail address of the user. A job code included in the “display message information” and a job code transmitted as the “supplementary information” are generated by the remote work service 103 at S1107 (FIG. 11).

At S3502, the printing job management unit 302 of the push notification server 106 searches for a device token associated with the mail address received at S3501 from among information stored in the storage unit 305 of the push notification server 106.

At S3503, the printing job management unit 302 of the push notification server 106 transmits a push notification to the mobile terminal 104 by using the device token searched at S3502. Thus, the mobile terminal 104 is notified of the job code by the remote work service 103 through the push notification server 106 interposed between the remote work service 103 and the mobile terminal 104. The push notification includes, for example, “display message information”, “operation information”, and “supplementary information” illustrated in FIG. 32. In a case where a plurality of device tokens are detected at S3502, in other words, in a case where a plurality of mobile terminals are associated with the user, the push notification may be transmitted to all searched mobile terminals.

At S3504, the UI control unit 306 of the mobile terminal 104 displays the “display message information” included in the received push notification on the screen of the mobile terminal 104 and becomes ready to receive a press-down operation on the message.

At S3505, based on press-down of the push notification at S3504, the printing job management unit 302 of the mobile terminal 104 activates the application 2000 associated with the push notification and executes processing indicated by the “operation information” included in the push notification. Accordingly, a printing job transmission request including the job code is transmitted to the household service 105.

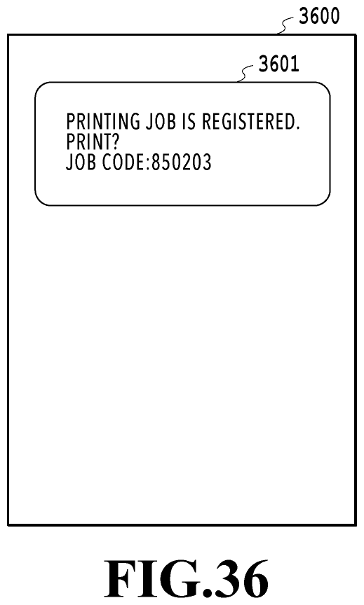

A screen 3600 illustrated in FIG. 36 is an example of a screen that the mobile terminal 104 displays on the display unit based on the push notification. The screen is displayed at S3504. The screen 3600 includes, in a display region 3601, the display message information included in the push notification received at S3503. FIG. 36 illustrates an example in which a message “Printing job is registered. Print? Job code: 850203” included as the display message information in the push notification is displayed in the display region 3601. When the display region 3601 on the screen 3600 is pressed down by the user, the printing job management unit 302 of the mobile terminal 104 activates the application 2000 associated with the push notification.

After having activated the application 2000, the printing job management unit 302 of the mobile terminal 104 executes operation indicated by the “operation information” included in in the push notification received at S3503. As described above with reference to FIG. 32, “ReleasePrintJob” is included as the operation information in the third embodiment. Thus, the printing job management unit 302 of the mobile terminal 104 executes operation related to transmission of a printing job transmission request to the household service 105, which is operation associated with the operation information “ReleasePrintJob”. Specifically, the processing at S2305 to S2307 and S2308 described above with reference to FIG. 23 is executed.

The push notification registration function may be executed based on printing job registration to the remote work service 103 as described above, but the timing of execution of the push notification registration function is not limited thereto. For example, menus related to the remote work service 103 are displayed based on press-down of the “remote work cloud print service” button 2011 in FIG. 20A. Then, a menu related to “push notification registration” may be selected from among the displayed menus by the user. In this case, the mobile terminal 104 executes the processing illustrated in FIG. 33 based on selection of the menu related to “push notification registration”.

In this manner, by using a push notification, it is possible to further improve usability and security for processing of printing job transmission to the image forming apparatus 102 by using the mobile terminal 104.

<5. Request Sending Processing by Mobile Terminal when Screen of Push Notification is Tapped>

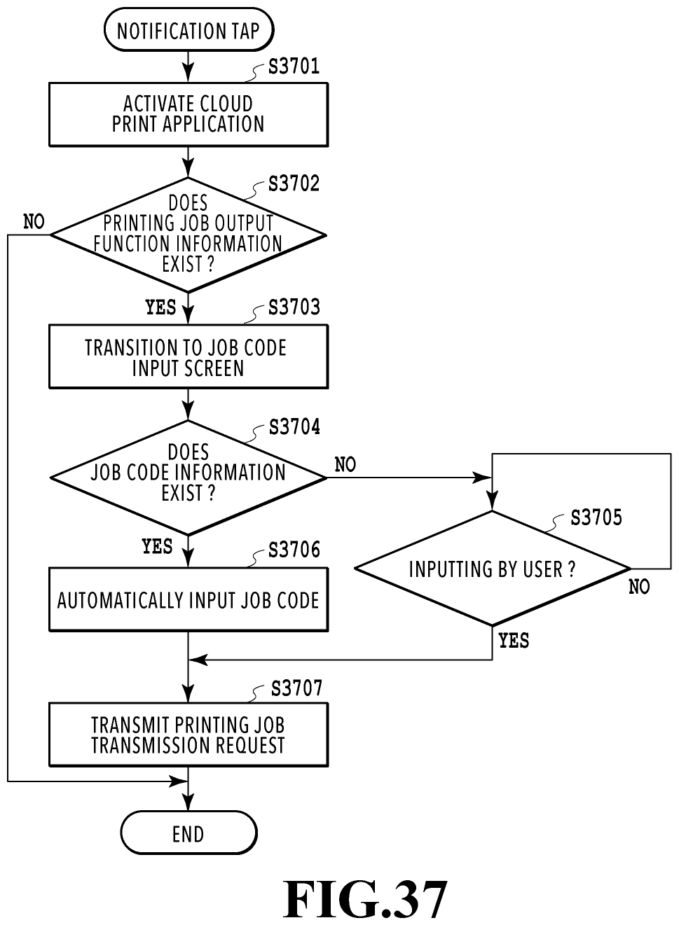

Further improvement of usability and security is desired for processing of printing job transmissions to the image forming apparatus 102 by using the mobile terminal 104. The third embodiment will be described below with reference to FIG. 37 for a method of using push notification to further improve usability and security related to processing of printing job transmission to the image forming apparatus 102 by using the mobile terminal 104.

An example of request sending processing by the mobile terminal 104 when a screen of a push notification is tapped on the mobile terminal 104 will be described below with reference to FIG. 37. In other words, example of processing in a state in which a push notification is received by the mobile terminal 104 will be described below. Specifically, an example of processing after the processing at S3504 is ended will be described below.

In a case where the push notification received at S3503 is pressed down at S3504, the printing job management unit 302 of the mobile terminal 104 activates the application 2000 associated with the push notification at S3701. Then, the application 2000 performs processing of information included in the notification. At S3702, whether a “printing job transmission function” that is processing indicated by “operation information” exists is determined by using a job code indicated by “supplementary information” included in the push notification. In a case where no information corresponding the “printing job transmission function” exists, the push notification is a notification for performing operation other than printing job transmission, and thus the current operation is ended and desired operation is performed by other determination processing. In a case where the “printing job transmission function” exists, the UI control unit 306 of the mobile terminal 104 presents the screen 2020 illustrated in FIG. 20B through the activated application 2000 at S3703. Specifically, the mobile terminal 104 obtains data of the screen 2020 by accessing the household service 105 and presents the screen 2020 to the user based on the data.

At S3704, the printing job management unit 302 of the mobile terminal 104 determines whether information related to a job code exists based on “supplementary information” included in the push notification pressed down at S3504. In a case where it is determined at S3704 that no information related to a job code exists, the application receives manual inputting of a job code on the screen 2020 at S3705. For example, a dialog for prompting the user to input a job code may be additionally displayed. In a case where information related to a job code is included in “supplementary information” included in the push notification, the job code is obtained and the processing is advanced to S3706. It is one large characteristic of the third embodiment that whether information related to “printing job transmission function” or “job code” is included in the push notification is determined to select either of the processing at S3705 and the processing at S3706.

At S3706, the printing job management unit 302 of the mobile terminal 104 inputs the job code obtained at S3703 to the input region 2021.

At S3707, the printing job management unit 302 of the mobile terminal 104 transmits, to the household service 105, a printing job transmission request to which the job code input at S3705 or S3706 is attached. Specifically, in a case where the button 2022 is pressed down, the mobile terminal 104 transmits, to the household service 105, a printing job transmission request to which the job code input to the input region 2021 is attached. In a case where the button 2023 is pressed down, a printing job deletion request to which the job code input to the input region 2021 is attached is transmitted to the household service 105. Accordingly, a printing job specified by the job code is deleted.

S3707 corresponds to S1125 illustrated in FIG. 12, and the processing at S1127 and later is executed thereafter. Although not described above, processing corresponding to the processing at S2301 to S2304 illustrated in FIG. 23 may be executed between S3701 and S3702. Similarly, processing corresponding to S2308 may be executed following S3707, and a result of the processing may be presented to the user. In the third embodiment, an application is activated at S3701 and screen transition on the application, such as S3703 is performed, but the entire processing may be executed in the background in an invisible manner to the user. In such a case, the user may be notified of processing completion and error by means of other notification or toast outputting.

In this manner, by using push notification, it is possible to omit an input operation of a job code by the user. Moreover, it is possible to further improve usability and security for processing of printing job transmission to the image forming apparatus 102 by using the mobile terminal 104.

### <6. OAO Authentication at Client Terminal>

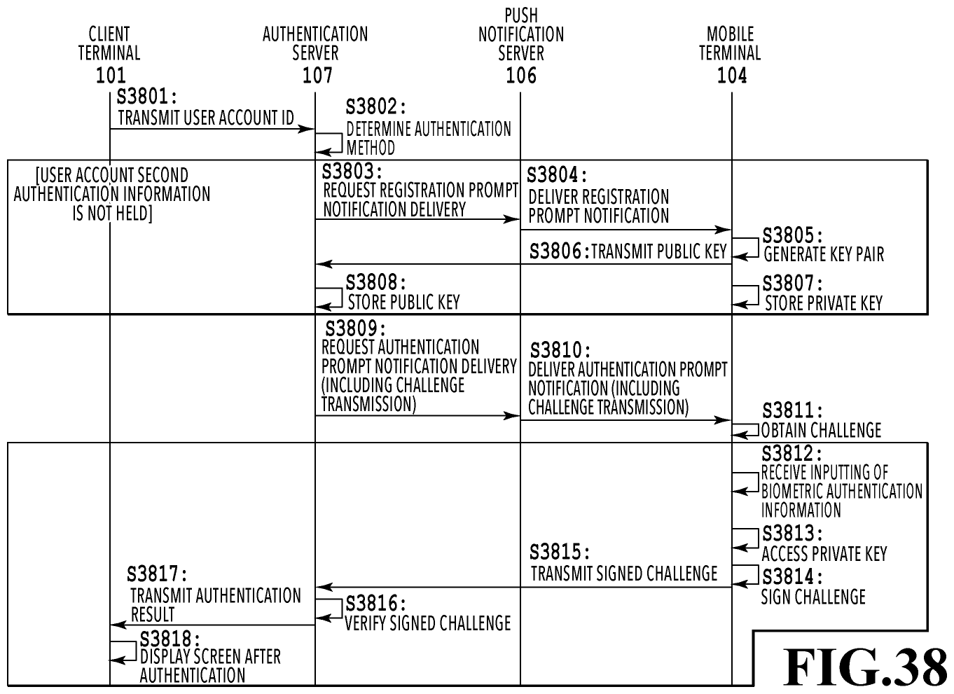

It is described above with reference to FIG. 11 that OAO authentication is performed for the client terminal 101 to log in to the remote work service 103 before the client terminal 101 transmits a printing job to the remote work service 103. Hereinafter, details of OAO authentication will be described with reference to FIG. 38.

At S3801, the client terminal 101 displays the screen 2800 illustrated in FIG. 28A. When a user account ID is input to the input region 2801 and the button 2802 is pressed down by the user, the client terminal 101 transmits the user account ID to the authentication server 107 at S3801.

At S3802, the authentication control unit 304 of the authentication server 107 executes, based on the user account ID transmitted from the client terminal 101, processing related to determination of an authentication method for a user corresponding to the user account ID. Specifically, it is checked whether the account second authentication information (for example, the public key illustrated in FIG. 29) of the user corresponding to the user account ID is stored in the storage unit 305 of the authentication server 107. In a case where the account second authentication information corresponding to the user account ID is stored, the processing is advanced to S3809 to execute authentication processing by an authentication method (for example, the public key encryption scheme) using the account second authentication information. In a case where no account second authentication information corresponding to the user account ID is stored, the processing is advanced to S3803 to execute registration processing of the account second authentication information. In a case where the account second authentication information is not used, authentication processing may be executed by an authentication method (for example, the password scheme) using account authentication information. As another method, the mobile terminal 104 of the user may be specified based on a phone number or a mail address so that authentication processing is executed by the one-time password scheme, or authentication processing may be executed by using both the password scheme and the one-time password scheme.

At S3803, the authentication control unit 304 of the authentication server 107 requests the push notification server 106 to deliver, to the mobile terminal 104 of the user, a notification that prompts registration of the account second authentication information. User identification information such as a mail address may be attached to the request to specify the mobile terminal 104 of the user. The authentication control unit 304 of the authentication server 107 cooperates with the remote work service 103 as necessary. For example, the authentication server 107 may request, through the remote work service 103, the push notification server 106 to deliver a notification that prompts registration of the account second authentication information. In a case where no information related to the user is held in the storage unit 305 of the push notification server 106, the mobile terminal 104 of the user may be specified through authentication by the one-time password scheme using a phone number or a mail address. Then, the mobile terminal 104 may be prompted to register the account second authentication information.

At S3804, the printing job management unit 302 of the push notification server 106 transmits, to the mobile terminal 104 of the user, a notification that prompts registration of the account second authentication information. Specifically, the mobile terminal 104 is specified based on mobile terminal identification information such as a device token associated with the user account ID (or user identification information such as a mail address) received from the authentication server 107 (or the remote work service 103). Then, a push notification that prompts registration of the account second authentication information is delivered to the mobile terminal 104. Examples of information included in the push notification are display message information “A key can be generated and a more secure authentication method can be used.” and operation information “MakeKey”. Authentication character string data (for example, challenge) may be included as supplementary information of the delivered push notification.

At S3805, based on reception of the notification that prompts registration of the account second authentication information, the authentication control unit 304 of the mobile terminal 104 generates a key pair of a private key and a public key. In a case where authentication character string data (for example, challenge) is included as supplementary information of the received push notification, the authentication character string data is signed by using the generated private key.

At S3806, the authentication control unit 304 of the mobile terminal 104 transmits the public key generated at S3805 to the authentication server 107. In a case where authentication character string data (for example, signed challenge) signed at S3805 is available, the signed authentication character string data may be transmitted to the authentication server 107 as well.

At S3807, the mobile terminal 104 stores the private key generated at S3805.

At S3808, the authentication control unit 304 of the authentication server 107 stores the public key received at S3806 in the storage unit 305 of the authentication server 107 in association with the user account ID received at S3801. In a case where the authentication character string data signed at S3806 is received as well, the signed authentication character string data may be verified by using the received public key, and the public key may be stored in the storage unit 305 of the authentication server 107 only in a case where the verification is correctly performed.

At S3809, the authentication control unit 304 of the authentication server 107 requests the push notification server 106 to deliver a notification that prompts authentication with the account second authentication information to the mobile terminal 104 of the user. Specifically, the authentication control unit 304 of the authentication server 107 transmits authentication character string data (for example, challenge) to the push notification server 106. The authentication control unit 304 of the authentication server 107 cooperates with the remote work service 103 as necessary. For example, the authentication server 107 may request, through the remote work service 103, delivery of the notification that prompts authentication with the account second authentication information to the push notification server 106. In a case where no information related to the user is held in the storage unit 305 of the push notification server 106, the mobile terminal 104 of the user may be specified through authentication by the one-time password scheme using a phone number or a mail address. Then, the mobile terminal 104 may be prompted to perform authentication with the account second authentication information.

At S3810, the printing job management unit 302 of the push notification server 106 transmits a push notification including authentication character string data (for example, challenge) as supplementary information to the mobile terminal 104. Specifically, the mobile terminal is specified based on mobile terminal identification information such as a device token associated with the user account ID (or user identification information such as a mail address) received from the authentication server 107 (or the remote work service 103). Then, a push notification that prompts authentication with the account second authentication information is delivered to the mobile terminal 104. Examples of information included in the push notification are display message information “Execute authentication by using a key?” and operation information “OauthByKey”.

At S3811, based on reception of the notification that prompts authentication with the account second authentication information, the authentication control unit 304 of the mobile terminal 104 obtains the authentication character string data (for example, challenge) from the supplementary information of the notification.

At S3812, based on the challenge reception at S3811, the UI control unit 306 of the mobile terminal 104 presents the screen 2810 illustrated in FIG. 28B and becomes ready to receive inputting of information related to authentication by the user. The screen 2810 is displayed on the mobile terminal 104, for example, through the application 2000.

The screen 2810 illustrated in FIG. 28B is a screen that receives inputting of information related to user authentication. The screen 2810 notifies the user of the necessity of biometric authentication (for example, fingerprint authentication or face authentication). The biometric authentication is needed to access highly confidential information on the mobile terminal 104, and in the third embodiment, is needed to access the user private key stored in the storage unit 305 of the mobile terminal 104.

At S3813, in a case where the biometric authentication by the user is successful, the authentication control unit 304 of the mobile terminal 104 accesses the private key stored in the storage unit 305 of the mobile terminal 104.

At S3814, the authentication control unit 304 of the mobile terminal 104 signs the authentication character string data received from the authentication server 107 by using the private key stored in the storage unit 305 of the mobile terminal 104.

At S3815, the authentication control unit 304 of the mobile terminal 104 transmits the authentication character string data (for example, signed challenge) signed at S3814 to the authentication server 107.

At S3816, the authentication control unit 304 of the authentication server 107 verifies the authentication character string data (for example, signed challenge) received from the mobile terminal 104 by using the public key corresponding to the user name stored in the storage unit 305 of the authentication server 107. Specifically, it is determined that authentication is successful in a case where the received authentication character string data (for example, signed challenge) can be decrypted by using the public key. It is determined that authentication is unsuccessful in a case where the received authentication character string data (for example, signed challenge) cannot be decrypted by using the public key. In this case, the authentication control unit 304 of the authentication server 107 may request a predetermined authentication service for authentication of the user.

At S3817, based on the verification of the authentication character string data (for example, signed challenge) at S3816, the authentication control unit 304 of the authentication server 107 transmits the authentication result to the mobile terminal 104. In the third embodiment, it is assumed that the verification of the authentication character string data (for example, signed challenge) is successful and the user authentication is successful.

At S3818, the UI control unit 306 of the mobile terminal 104 presents the screen 1720 illustrated in FIG. 17C through the application 2000. Specifically, the mobile terminal 104 obtains data of the screen 1720 by accessing the remote work service 103 and presents the screen 1720 to the user based on the data. In the third embodiment, the screen 1720 is presented as a screen in a case where the verification of the authentication character string data (for example, signed challenge) is successful, but the screen 2800 is presented in a case where the verification of the authentication character string data (for example, signed challenge) is unsuccessful. In this case, the screen 2800 is presented with a message indicating that authentication is necessary again because authentication is unsuccessful.

### <7. Other>

In the third embodiment, only AOA authentication (S1119) may be performed at the mobile terminal 104 as in the first embodiment, or both OAO authentication (S2601) and AOA authentication (S1119) may be performed as in the second embodiment. Alternatively, only OAO authentication (S2601) may be performed at the mobile terminal 104.

According to the third embodiment, it is possible to further improve usability and security for processing of printing job registration by using the client terminal 101 and printing job transmission to the image forming apparatus 102 by using the mobile terminal 104.

### Fourth Embodiment

The fourth embodiment is basically the same as the first embodiment. In the first embodiment, the user inputs a job code to the mobile terminal 104. However, in the fourth embodiment, the client terminal 101 displays a QR code (registered trademark) in which a job code is embedded. Then, the mobile terminal 104 obtains the job code by reading the QR code (registered trademark). Thus, in the fourth embodiment, the user does not need to input a job code to the mobile terminal 104.

### <1. System Configuration>

A system configuration according to the fourth embodiment is the same as illustrated in FIG. 1 according to the first embodiment.

### <2. Overall Processing Flow>

The operations and screens of the first embodiment are basically are the same in the fourth embodiment as well, and thus any duplicate description is omitted. In particular, processing up to registration of a printing job to the remote work service 103 by the client terminal 101 is the same as in the first embodiment, and thus duplicate description of the processing is omitted.

### <3. Overall Flow of Processing Related to QR Code (Registered Trademark)>

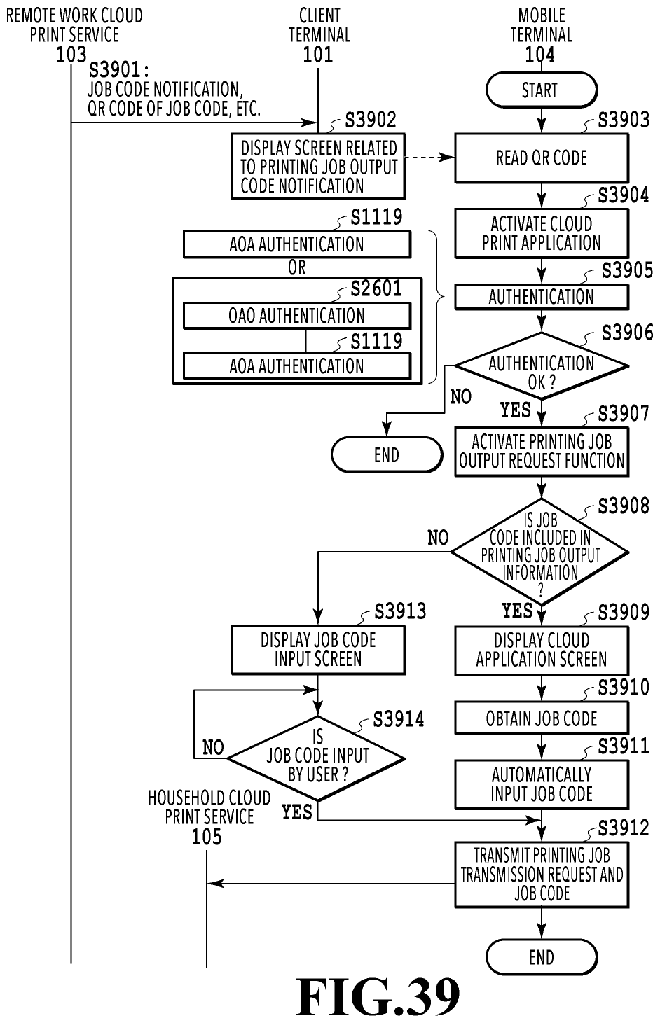

An example of processing at the printing job transmission system according to the fourth embodiment will be described below with reference to FIGS. 39 to 41. In particular, processing after a printing job is registered to the remote work service 103 by the client terminal 101 will be described below.

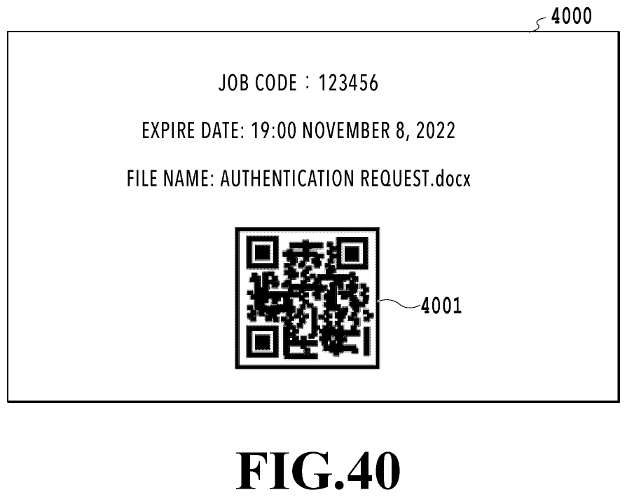

As illustrated in FIG. 39, at S3901, the remote work service 103 transmits data (job code, expire date, and the name of a file to be printed by the printing job) for displaying a screen 4000 as illustrated in FIG. 40 to the client terminal 101. Then, at S3902, the client terminal 101 displays the screen 4000 on the display unit. After S1107 illustrated in FIG. 11 is executed, S3901 is executed at the same timing as S1111 or at a timing before and after S1111.

As illustrated in FIG. 40, the screen 4000 includes a job code expressed as a character string, expire date, the name of a file to be printed by the printing job, and a QR code (registered trademark) 4001. The QR code (registered trademark) 4001 is added as compared to FIG. 17D. By viewing the screen 4000, the user can know that the printing job of a document identified by the file name is registered.

At S3902, the client terminal 101 may display the screen 4000 illustrated in FIG. 40 as in a case where the screen 3400 illustrated in FIG. 34 is displayed. Specifically, the client terminal 101 may display the screen 4000 as follows. The client terminal 101 obtains basic data of the screen 4000 by accessing the remote work service 103. Then, the client terminal 101 presents the screen 4000 to the user based on the basic data, and the job code, the expire date, and the name of a file to be printed by the printing job, which are received at S3901. However, the remote work service 103 may also transmit basic data for screen display to the client terminal 101 at S3901. In this case, at S3902, the client terminal 101 presents the screen 4000 to the user based on the basic data, the job code, the expire date, and the name of a file to be printed by the printing job, which are received at S3901.

The QR code (registered trademark) 4001 embeds information for causing the mobile terminal 104 to execute processing of requesting the remote work service 103 to transmit the printing job designated by the job code to the image forming apparatus 102. In the following description, this information is referred to as “transmission request information”.

The transmission request information is displayed in the format of the QR code (registered trademark) 4001 on the screen 4000, but may be displayed in any other format, such as a bar code, by which the transmission request information can be stored. The screen 4000 may be presented to the user, for example, through a medium such as a mail. The processing starting at S3901 may be executed only in a case where the printing job management unit 302 of the remote work service 103 determines that the device token of the mobile terminal 104 for push notification delivery is not registered in the push notification server 106.

However, the processing starting at S3901 may be executed even in a case where it is determined that the device token is registered. In other words, the processing starting at S3901 may be executed even in a case where push notification to the mobile terminal 104 in the third embodiment is performed. In this manner, even when the registered mobile terminal 104 cannot receive a push notification, the mobile terminal 104 can send a printing job transmission request by using the transmission request information embedded in the QR code (registered trademark) 4001.

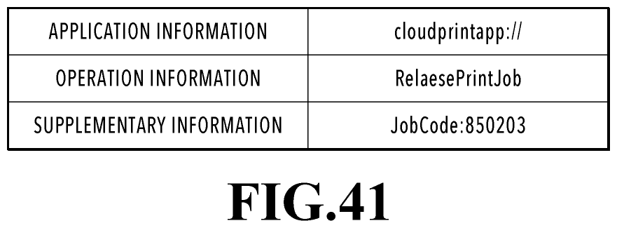

Examples of information included in the transmission request information embedded in the QR code (registered trademark) 4001 will be described below with reference to FIG. 41. As illustrated in FIG. 41, the transmission request information includes “application information”, “operation information”, and “supplementary information”.

The “application information” is information related to an application that is activated on the mobile terminal 104 when the mobile terminal 104 reads the QR code (registered trademark) 4001 by using a camera function. The “application information” is set to, for example, a URL scheme for activating an application. Having read the URL scheme, the mobile terminal 104 activates the application associated with the URL scheme. In the example illustrated in FIG. 41, “cloudprintapp://” is set as the application information. The application information is information that designates the application 2000.

The “operation information” is information related to operation executed by the mobile terminal 104 when the QR code (registered trademark) 4001 is read, and is set to, for example, information related to operation executable by the application associated with the above-described application information. The operation information includes a character string for executing a function to request printing job transmission and can execute the function to request printing job transmission together with activation of the application 2000. Thus, with the operation information, the application 2000 is not simply activated but, after activation, can proceed to execution of part related to the function to request printing job transmission, which is designated by the “operation information” in the application 2000. In the example illustrated in FIG. 41, “ReleasePrintJob” is set as the operation information. Information set as the operation information is not limited to a particular type but may be any information with which operation executable by the application associated with the above-described application information can be specified, and may be set to, for example, an identifier such as an operation ID.

The “supplementary information” is information that can be used by the mobile terminal 104 when executing operation set by the “operation information”. For example, the “supplementary information” is set to information used by the application associated with the above-described application information when executing the operation set by the “operation information”. In the example illustrated in FIG. 41, “JobCode: 850203” is set as the supplementary information. Accordingly, “850203” is set as a job code.

At S3903, the mobile terminal 104 reads the QR code (registered trademark) 4001 displayed on the screen 4000 displayed on the client terminal 101.

Based on the reading of the QR code (registered trademark) 4001 displayed on the screen 4000 of the client terminal 101 at S3903, the mobile terminal 104 activates the application 2000 at S3904. Specifically, a URL scheme for specifying and activating the application 2000 is included is the transmission request information, and the mobile terminal 104 having read the URL scheme activates the application 2000. The URL scheme includes a character string for executing the function to request printing job transmission (also referred to as a “transmission request function”), and the transmission request function can be activated at S3907 together with activation of the application 2000. After having read the QR code (registered trademark) 4001, the mobile terminal 104 may activate the application 2000 through a browser instead of directly activate the application 2000. In this case, the transmission request information embedded in the QR code (registered trademark) 4001 includes the URL of a page to be accessed by the browser. The browser may display explanation related to printing job outputting and include a URL link to an application store for downloading the application 2000. Such processing is effective, for example, in a case where no application 2000 is installed on the mobile terminal 104. The browser may include a URL scheme for activating the application 2000.

At S3905, the mobile terminal 104 executes authentication.

At S3906, the mobile terminal 104 determines whether the authentication at S3905 is successful. In a case where the authentication is not successful, the mobile terminal 104 determines NO and ends the processing. For example, the application 2000 is returned to an initial state (for example, a state in which the screen 2010 is displayed) or ended. In a case where the authentication is successful, the mobile terminal 104 determines YES and advances the processing to S3907.

At S3907, the mobile terminal 104 activates the transmission request function. Specifically, the printing job management unit 302 of the mobile terminal 104 starts execution of the “transmission request function” that is processing indicated by the “operation information” by using a job code indicated by the “supplementary information” included in the transmission request information.

At S3908, it is determined whether a job code is included as the supplementary information in the transmission request information embedded in the QR code (registered trademark) 4001 read at S3903. The processing is advanced to S3909 in a case where a job code is included, or the processing is advanced to S3913 in a case where no job code is included. Whether a job code is included may be set by the user in advance, or may be set for the transmission at S3901 or the display at S3902 for each printing job.

At S3909, the UI control unit 306 of the mobile terminal 104 presents a screen through the activated application 2000. The presented screen may be a standby screen (not illustrated) or the screen 2020 illustrated in FIG. 20B. In a case where the standby screen is presented, a progress indicator may be presented until the processing at S3909 to S3911 ends, or the progress may be presented in percentage. In a case where the screen 2020 is presented, the mobile terminal 104 obtains data of the screen 2020 by accessing the household service 105 and presents the screen 2020 to the user based on the data.

At S3910, the printing job management unit 302 of the mobile terminal 104 obtains a job code from the “supplementary information” included in the transmission request information embedded in the QR code (registered trademark) 4001.

At S3911, the printing job management unit 302 of the mobile terminal 104 inputs the job code obtained at S3910 to the input region 2021.

At S3913, the mobile terminal 104 displays the screen 2020 illustrated in FIG. 20B.

At S3914, the mobile terminal 104 receives inputting of a job code to the input region 2021 on the screen 2020 by the user.

The processing is advanced to S3912 from S3911 or S3914. At S3912, the printing job management unit 302 of the mobile terminal 104 transmits a job code to the household service 105 and requests the household service 105 to transmit a printing job to the image forming apparatus 102. The job code is the job code automatically input at S3911 or the job code received at S3914. Specifically, in a case where the button 2022 is pressed down, the mobile terminal 104 transmits the transmission request and the information (job code) input to the input region 2021 to the household service 105. Accordingly, the household service 105 is requested to transmit a printing job to the image forming apparatus 102.

S3912 corresponds to S1125 illustrated in FIG. 12, and the processing at S1127 and later continues from S3912.

In a case where the button 2023 is pressed down, a printing job specified by the job code is deleted by transmitting the information input to the input region 2021 to the household service 105. Specifically, the processing described above with reference to FIG. 25 is executed.

Although not described in the fourth embodiment, the processing corresponding to S2302 to S2304 may be executed before advancing to S3907 in the case of YES at S3906. Similarly, S2308 may be executed after S3912 and a processing result may be presented to the user.

In this manner, by using the QR code (registered trademark) 4001, it is possible to omit an input operation of a job code by the user. Moreover, it is possible to further improve usability and security for printing job outputting by using the mobile terminal 104.

### <4. Other>

At S3905, only AOA authentication (S1119) may be performed at the mobile terminal 104 as in the first embodiment, or both OAO authentication (S2601) and AOA authentication (S1119) may be performed as in the second embodiment. Alternatively, only OAO authentication (S2601), at the mobile terminal 104 may be performed.

According to the fourth embodiment, it is possible to further improve usability and security for printing job registration by using the client terminal 101 and printing job outputting by using the mobile terminal 104.

### OTHER EMBODIMENTS

Together with S1111 or in place of S1111, an electronic mail for notifying the user of a job code may be transmitted.

A job code can uniquely specify a printing job by itself in a predetermined range, but data other than a job code may be used in place of a job code as long as the data has such a function. Further, for example, data that can specify a printing job in combination with at least one or both of a printer ID and a user account ID may be used in place of a job code.

The remote work service 103 may request the household service 105 for job code generation, and the household service 105 may generate a job code. In this case, the household service 105 transmits the job code to the remote work service 103 before S1109.

Instead of obtaining a printer ID through AOA authentication at S1119, the household service 105 may obtain a printer ID at another step. For example, the mobile terminal 104 may obtain a printer ID and transmit the printer ID to the household service 105.

No printer ID may be transmitted at S1127. In this case, the verification at S1129 is performed only with a job code. The remote work service 103 may obtain a printer ID stored at S1109 by using the job code as a key. Alternatively, the household service 105 may store the job code and the printer ID in association between S1125 and S1127 and thereafter obtain the printer ID by using the job code received at S1135 as a key.

The remote work service 103 may obtain no printer ID through OAO authentication at S1101. In this case, the verification at S1129 is performed only with a job code. The remote work service 103 specifies, with a printer ID received at S1127, the image forming apparatus 102 to which a printing job is to be transmitted.

A step for changing printing settings based on an operation from the user may be provided between S1135 and S1137.

An information processing apparatus for achieving the function of the remote work service 103 and an information processing apparatus for achieving the function of the household service 105 may be integrated. In this case, message communication between the remote work service 103 and the household service 105 is message communication between functional blocks.

In the above-described embodiments, a public key scheme using a private key and a public key as encryption keys is used, but a shared key scheme using a shared key as an encryption key may be used.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like. While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-131414, Japanese Patent Application No. 2023-131355, Japanese Patent Application No. 2023-131366, Japanese Patent Application No. 2023-131440, Japanese Patent Application No. 2023-131454, Japanese Patent Application No. 2023-131480, and Japanese Patent Application No. 2023-131266, which are filed on Aug. 10, 2023, and which are hereby incorporated by reference wherein in their entirety.

What is claimed is:

1. A system comprising a printing apparatus, a first terminal, and a second terminal, wherein
the first terminal includes a first transmission unit configured to transmit a printing job for causing the printing apparatus to execute printing,
the second terminal includes
a reception unit configured to receive inputting of predetermined information generated based on the transmission of the printing job by the first terminal, and
a second transmission unit configured to transmit, based on the reception of inputting of the predetermined information, a request for causing the printing apparatus to execute printing based on the printing job transmitted by the first terminal, and
the printing apparatus includes a printing unit configured to execute, based on the transmission of the request, printing based on the printing job transmitted by the first terminal.

2. The system according to claim 1, wherein
the printing job is transmitted from the first terminal to a predetermined cloud service, and
the printing apparatus executes printing based on the printing job transmitted by the first terminal when the printing job transmitted by the first terminal is transmitted to the printing apparatus through the predetermined cloud service.

3. The system according to claim 2, wherein
the predetermined information is generated by the predetermined cloud service, and
the predetermined information generated by the predetermined cloud service is transmitted to at least one of the first terminal and the second terminal.

4. The system according to claim 2, wherein
the predetermined information is generated by the predetermined cloud service,
the predetermined information generated by the predetermined cloud service is transmitted to a push notification server, and
the predetermined information transmitted to the push notification server is transmitted to the second terminal.

5. The system according to claim 2, wherein
the request is transmitted to another cloud service different from the predetermined cloud service,
the request is transmitted from the other cloud service to the predetermined cloud service based on the transmission of the request to the other cloud service,
the printing job is transmitted to the other cloud service based on the transmission of the request from the other cloud service to the predetermined cloud service, and
the printing job transmitted to the other cloud service is transmitted to the printing apparatus.

6. The system according to claim 5, wherein
identification information of the printing apparatus is included in the request transmitted from the other cloud service to the predetermined cloud service, and
the printing job corresponding to the identification information is transmitted to the other cloud service.

7. The system according to claim 1, wherein
the first terminal includes a display control unit configured to display the predetermined information based on the transmission of the printing job by the first terminal,
the second terminal includes a display control unit configured to display an input screen for receiving inputting of the predetermined information from a user, and
the second terminal receives inputting of the predetermined information when the predetermined information displayed by the first terminal is input to the input screen by the user.

8. The system according to claim 1, wherein
the first terminal includes a display control unit configured to, based on the transmission of the printing job by the first terminal, display a QR code containing the predetermined information, and
the second terminal receives inputting of the predetermined information when an image of the QR code displayed by the first terminal is captured by the second terminal.

9. The system according to claim 1, wherein
the second terminal further includes a reception unit configured to receive a push notification including the predetermined information, and
the second terminal receives inputting of the predetermined information when the push notification is received.

10. The system according to claim 1, wherein
the second terminal further includes an authentication unit configured to execute processing for executing authentication based on predetermined account information that corresponds to a predetermined application included in the second terminal and is not input to the second terminal by a user but is obtained by the second terminal, and
the request for causing the printing apparatus to execute printing based on the printing job transmitted by the first terminal is transmitted based on success of the authentication based on the account information and based on the reception of inputting of the predetermined information.

11. The system according to claim 1, wherein
the second terminal further includes an authentication unit configured to execute processing for executing authentication based on predetermined account information that corresponds to a user of the second terminal and is obtained by the second terminal through inputting to the second terminal by the user, and
the request for causing the printing apparatus to execute printing based on the printing job transmitted by the first terminal is transmitted based on success of the authentication based on the account information and based on the reception of inputting of the predetermined information.

12. The system according to claim 1, wherein
the second terminal further includes
a first authentication unit configured to execute processing for executing first authentication based on predetermined account information that corresponds to a predetermined application included in the second terminal and is not input to the second terminal by a user but is obtained by the second terminal, and
a second authentication unit configured to execute processing for executing second authentication based on predetermined account information that corresponds to the user of the second terminal and is obtained by the second terminal through inputting to the second terminal by the user, and
the request for causing the printing apparatus to execute printing based on the printing job transmitted by the first terminal is transmitted based on success of one of the first authentication and the second authentication and based on the reception of inputting of the predetermined information.

13. The system according to claim 12, wherein
the second terminal further includes a display control unit configured to display a predetermined button for executing the second authentication on a screen displayed by the predetermined application included in the second terminal, and
processing for executing the second authentication is executed after the predetermined button is operated.

14. The system according to claim 13, further comprising a control unit configured to control whether to display the predetermined button based on information related to the printing apparatus and registered in the predetermined application.

15. The system according to claim 1, wherein
the second terminal further includes a display control unit configured to display a specific button corresponding to a function to transmit the request on a screen displayed by a predetermined application included in the second terminal, and
the request is transmitted after the specific button is operated.

16. The system according to claim 15, further comprising a control unit configured to control whether to display the specific button based on information related to the printing apparatus and registered in the predetermined application.

17. The system according to claim 15, wherein inputting of the predetermined information is received after the predetermined button is operated.

18. The system according to claim 15, wherein the predetermined application also displays a button for causing the printing apparatus to print a picture or a document stored in the second terminal.

19. The system according to claim 1, wherein the request transmitted from the second terminal includes the input predetermined information.

20. A method of controlling a system comprising a printing apparatus, a first terminal, and a second terminal, wherein
a method on the first terminal includes transmitting a printing job for causing the printing apparatus to execute printing,
a method on the second terminal includes
receiving inputting of predetermined information issued based on the transmission of the printing job by the first terminal, and
transmitting, based on the reception of inputting of the predetermined information, a request for causing the printing apparatus to execute printing based on the printing job transmitted by the first terminal, and
a method on the printing apparatus includes executing, based on the transmission of the request, printing based on the printing job transmitted by the first terminal.
